(19) United States
(12) Patent Application Publication
(10) Pub. No.: US 2007/0077373 A1
(43) Pub. Date: Apr. 5, 2007

(54) Polymer film and polarizing plate and liquid crystal display device using the same

(75) Inventors: Hiromoto Haruta, Minami-Ashigara-shi (JP); Osamu Takahashi, Haibara-gun (JP); Mamoru Sakurazawa, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/528,260

(22) Filed: Sep. 28, 2006

(30) Foreign Application Priority Data
Sep. 30, 2005 (JP) P2005-288955

(51) Int. Cl. C09K 19/00

(52) U.S. Cl. 428/1.31

(57) ABSTRACT

A polymer film, which comprises: at least one liquid crystalline compound; and a compound having a dielectric constant ε of 4.0 or more, wherein a haze of the polymer film is 1.5% or less; and a polarizing plate and a liquid crystal display device using the polymer film.

### BACKGROUND OF THE INVENTION

1. Field of the Invention

This invention relates to a polymer film and a polarizing plate and a liquid crystal display device using the same. More specifically speaking, it relates to a polymer film having a high retardation and a small haze, and a polarizing plate and a liquid crystal display device with the use of the same showing a small viewing angle-dependency in tint change and little light leakage in the crossed Nicols configuration, having a high front contrast and being excellent in visibility.

2. Description of the Related Art

Uses of liquid crystal display devices have been increasing year by year as space-saving image display devices running at low voltage. Although large viewing angle-dependency of images has been considered as a serious problem in liquid crystal display devices, high-viewing angle liquid crystal modes characterized by having a low luminance in black display and a high contrast have been put into practical use in recent years. As a result, demand for liquid crystal display devices has been quickly expanding even in the market with a need for large screens and high-definition images such as TV sets.

With the improvements in the performance and contrast in liquid crystal display devices, there have been required optically compensatory films having elevated retardations and improved transparency.

In recent years, on the other hand, there have been proposed optically compensatory films made of cellulose acylate films even in the cases of requiring optically compensatory members having such high retardations. To elevate the retardation of a cellulose acylate film, there has been known a technique using a retardation raising agent having an aromatic ring (JP-A-2002-202411). However, there has been required to develop a technique whereby a higher retardation can be imparted and desired optical characteristics can be controlled over a broader scope.

### SUMMARY OF THE INVENTION

Accordingly, an object of the invention is to provide a polymer film, which has a high retardation and a small haze, and a polarizing plate and a liquid crystal display device with the use of the film showing a small viewing angle-dependency in tint change and little light leakage in the crossed Nicols configuration, having a high front contrast and being excellent in visibility.

The present invention is as follows.

(1) A polymer film, which comprises:

at least one liquid crystalline compound; and

a compound having a dielectric constant ε of 4.0 or more,

wherein a haze of the polymer film is 1.5% or less.

(2) The polymer film as described in (1) above, which comprises a cellulose acylate. (3) The polymer film as described in (1) or (2) above, which is formed by stretching.

(4) The polymer film as described in any of (1) to (3) above,

wherein a content of the compound having a dielectric constant ε of 4.0 or more is 5% by mass or more based on a polymer material of the polymer film.

(5) The polymer film as described in any of (1) to (4) above,

wherein the at least one liquid crystalline compound is a rod-shaped or discotic compound having three or more aromatic rings. (6) The polymer film as described in any of (1) to (5) above,

wherein the at least one liquid crystalline compound is represented by formula (1):
Ar¹-L¹ [symbol] Ar²-L² [symbol] ₙ-Ar³ Formula (1)

wherein Ar¹, Ar² and Ar³ each independently represents an aryl group or an aromatic heterocycle;

L¹ and L² each independently represents a single bond or a divalent linking group; and

n is an integer of 3 or more, provided that Ar² and L² may be either the same or different.

(7) The polymer film as described in any of (1) to (6) above, which has an in-plane retardation and a retardation in a thickness-direction satisfying following expressions (A) and (B):
30 nm<|Re(590)|<300 nm (A)
30 nm<Rth(590)<400 nm (B)

wherein Re(590) indicates an in-plane retardation (unit: nm) of the polymer film at a wavelength of 590 nm; and

Rth(590) indicates a retardation in a thickness-direction (unit: nm) of the polymer film at a wavelength of 590 nm.

(8) The polymer film as described in any of (1) to (7) above,

wherein the compound having a dielectric constant ε of 4.0 or more is a compound represented by any of formulae (S-1) to (S-7):

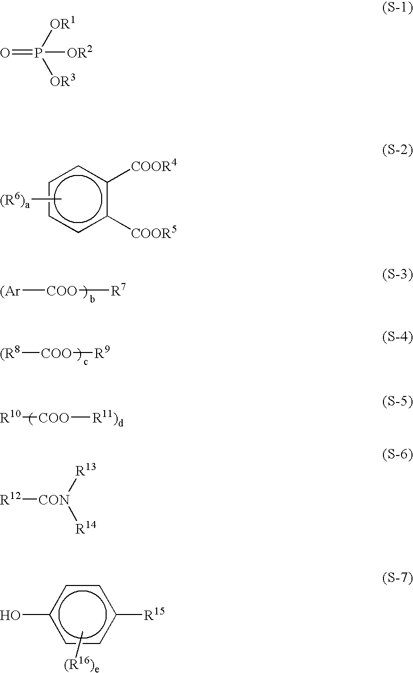

wherein in formula (S-1), R¹, R² and R³ each independently represents an alkyl group, a cycloalkyl group or an aryl group;

in formula (S-2), R⁴ and R⁵ each independently represents an alkyl group, a cycloalkyl group or an aryl group; R⁶ represents a halogen atom, an alkyl group, an alkoxy group, an aryloxy group or an alkoxycarbonyl group; and a is an integer of from 0 to 3, and when a is 2 or more, the plural number of R⁶s may be either the same or different;

in formula (S-3), Ar represents an aryl group; b is an integer of from 1 to 6; and R⁷ represents a hydrocarbon group having a valency of b or hydrocarbon groups bonded together via an ether bond;

in formula (S-4), R⁸ represents an alkyl group or a cycloalkyl group; c is an integer of from 1 to 6; and R⁹ represents a hydrocarbon group having a valency of c or hydrocarbon groups bonded together via an ether bond;

in formula (S-5), d is an integer of from 2 to 6; R¹⁰ represents a hydrocarbon group having a valency of d, provided that an aromatic group is excluded; and R¹¹ represents an alkyl group, a cycloalkyl group or an aryl group;

in formula (S-6), R¹², R¹³ and R¹⁴ each independently represents an alkyl group, a cycloalkyl group or an aryl group, and R¹² and R¹³, or R¹³ and R¹⁴ may be bonded together to form a ring; and

in formula (S-7), R¹⁵ represents an alkyl group, a cycloalkyl group, an alkoxycarbonyl group, an alkylsulfonyl group, an arylsulfonyl group, an aryl group or a cyano group; R¹⁶ represents a halogen atom, an alkyl group, a cycloalkyl group, an aryl group, an alkoxy group or an aryloxy group; and e is an integer of 0 to 3, and when e is 2 or more, the plural number of R¹⁶s may be either the same or different.

(9) A polarizing plate, which comprises:

a polarizer; and

at least two protective films provided in both sides of the polarizer,

wherein at least one of the at least two protective films is a polymer film as described in any of (1) to (8) above.

(10) A liquid crystal display device, which comprises:

a liquid crystal cell; and

at least two polarizing plates provided in both sides of the liquid crystal cell,

wherein at least one of the at least two polarizing plates is a polarizing plate as described in (9) above.

(11) A liquid crystal display device as described in (10) above,

wherein the liquid crystal cell is of a VA mode.

### BRIEF DESCRIPTION OF THE DRAWINGS

FIG. 1 is a drawing illustrating the polarizing plate of the invention constructed in Example; and

FIG. 2 is a drawing illustrating the method of measuring light leakage in the invention.

### DETAILED DESCRIPTION OF THE INVENTION

Next, the invention will be described in greater detail.

The invention relates to a polymer film which contains at least one liquid crystalline compound and a compound having a dielectric constant ε of 4.0 or more, wherein the haze of the film is 1.5% or less.

The inventors have found out that, by adding a liquid crystalline compound to a polymer film, the liquid crystalline compound forms aggregates in the film and the liquid crystalline compound molecules are oriented within the aggregates to develop a high retardation.

In the case where the aggregates are too large, it is feared that the haze of the film is worsened thereby. As the results of the subsequent studies, the inventors have found out that the size of these liquid crystalline compound aggregates can be controlled by using together a compound having a dielectric constant ε of 4.0 or more and the problem of the worsening in haze can be overcome by controlling the aggregate size.

More specifically speaking, the compound to be used together with the liquid crystalline compound is, for example, a plasticizer having a dielectric constant ε of 4.0 or more. Thus, the size of the aggregates of the liquid crystalline compound can be reduced and the haze can be regulated. In the case where the dielectric constant ε is less than 4.0, the aggregates of the liquid crystalline compound become too large in the film and thus the haze is worsened, i.e., exceeding 1.5%.

In the case where the dielectric constant ε is more than 6.5, on the other hand, the haze can be regulated but the retardation development is worsened due to the excessively small size of the aggregates of the liquid crystalline compound. That is, it is preferable that the dielectric constant ε is 4.0 or more but not more than 6.5, more preferably 4.0 or more but not more than 5.0.

The “dielectric constant ε” as used in the invention can be measured by, for example, using a dielectric constant tester TRS-10T™ manufactured by ANDO DENKISHA at a measurement temperature of 25° C. and a measurement frequency of 10 kHz.

(Liquid Crystalline Compound)

The film of the invention contains at least one liquid crystalline compound. As the liquid crystalline compound to be used in the invention, a compound having a high intrinsic refractive index. Concerning the structure, a rod-shaped compound or a discotic compound is preferred. Among all, a compound having three or more aromatic ring is preferable. A rod-shaped compound having from 3 to 9, in particular, from 5 to 7 aromatic rings is preferred. In the case of a discotic compound, one having from 4 to 16, in particular, from 5 to 10 aromatic rings is preferred.

It can be easily confirmed whether a compound is a liquid crystalline compound or not by using methods reported in various documents (for example, Ekisho Binran, p. 4, ed. by Ekisho Binran Henshu-linkai, Maruzen; and Ekisho no Kiso to Oyo, p. 3>, JISC).

Now, the liquid crystalline compound to be used in the invention will be described in greater detail.

As the liquid crystalline phase of the liquid crystalline compound of the invention in a liquid crystalline state, nematic phase, discoticnematic phase, smectic phase, columnar phase and other high order liquid crystalline phases can be exemplified, and nematic phase, discoticnematic phase and smectic phase are preferred.

As the liquid crystalline compound to be used in the invention, a compound having a high intrinsic birefringence and can be easily oriented in a film, i.e., a compound having large capability to develop retardation. In this case, in order to obtain high capability to develop retardation, a liquid crystalline phase transition temperature of the liquid crystalline compound is preferably from 50° C. to 300° C., more preferably from 70° C. to 250° C., and further more preferably from 100° C. to 200° C. By setting a liquid crystalline phase transition temperature of the liquid crystalline compound into such temperature ranges, it is possible to form a liquid crystalline phase in these liquid crystalline compounds when polymer film is subjected to heat treatment, thereby possible to highly orient the compounds.

By using such a liquid crystalline compound, retardation can be controlled over a broad scope by conducting orientation by, for example, stretching. In the case orienting a rod-shaped compound, the in-plane anisotropy of the film can be elevated and the in-plane retardation and the retardation in thickness-direction can be raised by elevating the degree of orientation of the compound. In the case of orienting a discotic liquid crystalline compound in parallel to the film surface, on the other hand, the retardation in thickness-direction can be raised.

As the liquid crystalline compound to be used in the invention, a compound represented by the following formula (1) is preferred. The preferable addition level of the liquid crystalline compound to be used in the invention is from, for example, 0.1 to 20% by mass, preferably from 1 to 15% by mass and more preferably from 1 to 10% by mass per 100 parts by mass of the polymer. (In this specification, mass ratio is equal to weight ratio.) In the case of using cellulose acylate as the polymer film material, the liquid crystalline compound may be directly added to a cellulose acylate solution. Alternatively, it is also possible that a controller solution is preliminarily prepared by, for example, mixing a solvent with the liquid crystalline compound by stirring, this controller solution is added to a small portion of a cellulose acylate solution prepared separately, and, after stirring, it is added to the main cellulose acylate dope solution. The invention is not particularly restricted to such addition procedures.

As the liquid crystalline compound to be used in the invention, a compound represented by the following formula (1) is preferred.
Ar¹-L¹ [symbol] Ar²-L² [symbol] ₙ-Ar³ Formula (1)
wherein Ar¹, Ar² and Ar³ independently represent each an aryl group or an aromatic heterocycle; L¹ and L² independently represent each a single bond or a divalent linking group; and n is an integer of 3 or more, provided that Ar² and L² may be either the same or different.

Next, the compound represented by the formula (1) will be described in greater detail.

In the formula (1), Ar¹, Ar² and Ar³ independently represent each an aryl group or an aromatic heterocycle; L¹ and L² independently represent each a single bond or a divalent linking group; and n is an integer of 3 or more. Ar² and L² may be either the same or different.

Aryl groups represented by Ar¹, Ar² and Ar³ are preferably aryl groups having from 6 to 30 carbon atoms. They may be either monocyclic groups or form fused rings with other rings. If possible, such an aryl group may have a substituent and examples of the substituent include the substituent T which will be described hereinafter.

Preferable examples of the aryl groups include those having from 6 to 20 carbon atoms, more preferably from 6 to 12 carbon atoms such as phenyl, p-methylphenyl and naphthyl.

Aromatic heterocycles represented by Ar¹, Ar² and Ar³ may be any heterocycles having at least one member selected from among an oxygen atom, a nitrogen atom and a sulfur atom. Preferable examples thereof are 5- or 6-membered aromatic heterocycles having at least one member selected from among an oxygen atom, a nitrogen atom and a sulfur atom. If possible, such a heterocycle may have a substituent and examples of the substituent include the substituent T which will be described hereinafter.

Specific examples of the aromatic heterocycles include furan, pyrrole, thiophene, imidazole, pyrazole, pyridine, pyrazine, pyridazine, triazole, trizine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthridine, phenazine, tetrazole, benzimidazole, benzoxazole, benzthiazole, benzotriazole, tetrazaindene, pyrrolotriazole, pyrazotriazole and so on. Preferable examples of the aromatic heterocycles include benzimidazole, benzoxazole, benzthiazole and benztriazole.

In the formula (1), L¹ and L² represent each a single bond or a divalent linking group. Preferable example of the divalent linking group include a group represented by —NR⁷— (wherein R⁷ represents a hydrogen atom or an alkyl group or an aryl group which may have a substituent), —SO₂—, —CO—, an alkylene group, a substituted alkylene group, an alkenylene group, a substituted alkenylene group, an alkynylene group, —O—, —S—, —SO— and a group obtained by combining two or more of these divalent groups. Among them, —O—, —CO—, —SO₂NR⁷—, —NR⁷SO₂—, —CONR⁷—, —NR⁷CO—, —COO—, —OCO— and an alkynylene group are more preferable.

In the formula (1), Ar² is bonded to L¹ and L². In the case where Ar² is a phenylene group, it is most preferred that L¹-Ar²-L² and L²-Ar²-L² are located in the para-configuration (1,4-positions).

n is an integer of 3 or more, preferably from 3 to 7 and more preferably from 3 to 5.

In the compounds represented by the formula (1), a compound represented by the following formula (2) is preferred. Next, the formula (2) will be described in greater detail.

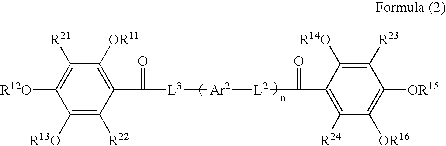

In the formula (2), R¹¹, R¹², R¹³, R¹⁴, R¹⁵, R¹⁶, R²¹, R²², R²³ and R²⁴ independently represent each a hydrogen atom or a substituent; Ar² represents an aryl group or an aromatic heterocycle; L² and L³ independently represent each a single bond or a divalent linking group; and n is an integer of 3 or more, provided that Ar² and L² may be either the same or different.

Examples of Ar², L² and n are the same as in the formula (1). L³ represents a single bond or a divalent linking group. Preferable examples of the divalent linking group include a group represented by —NR⁷— (wherein R⁷ represents a hydrogen atom or an alklyl group or an aryl group which may have a substituent), an alkylene group, a substituted alkylene group, —O— and a group obtained by combining two or more of these divalent groups. Among them, —O—, —NR⁷—, —NR⁷SO₂— and —NR⁷CO—, are more preferable.

R¹¹, R¹², R¹³, R ¹⁴, R¹⁵ and R¹⁶ independently represent each a hydrogen atom or a substituent. A hydrogen atom, an alkyl group and an aryl group are preferable, a hydrogen atom, an alkyl group having from 1 to 4 carbon atoms (for example, methyl, ethyl, propyl or isopropyl group) and an aryl group having from 6 to 12 carbon atoms (for example, phenyl or naphthyl group) are more preferable and an alkyl group having from 1 to 4 carbon atoms is more preferable.

R²¹, R²², R²³ and R²⁴ independently represent each a hydrogen atom or a substituent. A hydrogen atom, an alkyl group an alkoxy group and a hydroxyl group are preferable, and a hydrogen atom, an alkyl group (preferably having from 1 to 4 carbon atoms, more preferably a methyl group) are more preferable.

Next, the substituent T as described above will be illustrated.

Preferable examples of the substituent T include halogen atoms (for example, a fluorine atom, a chlorine atom, a bromine atom and an iodine atom), alkyl groups (preferably alkyl groups having from 1 to 30 carbon atoms such as methyl, ethyl, n-propyl, isopropyl, t-butyl, n-octyl and 2-ethylhexyl), cycloalkyl groups (preferably substituted or unsubstituted cycloalkyl groups having from 3 to 30 carbon atoms such as cyclohexyl, cyclopentyl and 4-n-dodecylcyclohexyl), bicycloalkyl groups (preferably substituted or unsubstituted bicycloalkyl groups having from 5 to 30 carbon atoms, i.e., monovalent groups remaining after removing a hydrogen atom from bicycloalkanes having from 5 to 30 carbon atoms such as bicyclo[1,2,2]heptan-2-yl, bicyclo[2,2,2]octan-3-yl), alkenyl groups (preferably substituted or unsubstituted alkenyl groups having from 2 to 30 carbon atoms such as vinyl and allyl), cycloalkenyl groups preferably substituted or unsubstituted cycloalkenyl groups having from 3 to 30 carbon atoms, i.e., monovalent groups remaining after removing a hydrogen atom from cycloalkenes having from 3 to 30 carbon atoms such as 2-cyclopenten-1-yl and 2-cyclohexen-1-yl), bicycloalkenyl groups (substituted or unsubstituted bicycloalkenyl groups, preferably substituted or unsubstituted bicycloalkenyl groups having from 5 to 30 carbon atoms, i.e., monovalent groups remaining after removing a hydrogen atom in bicycloalkenes having one double bond such as bicyclo[2,2,1]hept-2-en-1-yl and bicyclo[2,2,2]oct-2-en-4-yl), alkynyl groups (preferably substituted or unsubstituted alkynyl groups having from 2 to 30 carbon atoms such as ethynyl and propargyl), aryl groups (preferably substituted or unsubstituted aryl groups having from 6 to 30 carbon atoms such as phenyl, p-tolyl and naphthyl), heterocycles (preferably monovalent groups remaining after removing one hydrogen atom from substituted or unsubstituted and aromatic or non-aromatic 5- or 6-membered heterocyclic compounds, more preferably 5- or 6-membered aromatic heterocycles having from 3 to 30 carbon atoms such as 2-furyl, 2-thienyl, 2-pyrimidinyl and 2-benzthiazolyl), a cyano group, a hydroxyl group, a nitro group, a carboxyl group, alkoxy groups (preferably substituted or unsubstituted alkoxy groups having from 1 to 30 carbon atoms such as methoxy, ethoxy, isopropoxy, t-butoxy, n-octyloxy and 2-methoxyethoxy), aryloxy groups (preferably substituted or unsubstituted aryloxy groups having from 6 to 30 carbon atoms such as phenoxy, 2-methylphenoxy, 4-t-butylphenoxy, 3-nitrophenoxy and 2-tetradecanoylaminophenoxy), silyloxy groups (preferably silyloxy groups having from 3 to 20 carbon atoms such as trimethylsilyloxy and t-butyldimethylsilyloxy), heterocyclic oxy groups (preferably substituted or unsubstituted heterocyclic oxy groups having from 2 to 30 carbon atoms such as 1-phenyltetrazol-5-oxy and 2-tetrahydropyranyloxy), acyloxy groups (preferably a formyloxy group, substituted or unsubstituted alkylcarbonyloxy groups having from 2 to 30 carbon atoms and substituted or unsubstituted arylcarbonyloxy groups having from 6 to 30 carbon atoms such as formyloxy, acetyloxy, pivaloyloxy, stearoyloxy, benzoyloxy and p-methoxyphenylcarbonyloxy), carbamoyloxy groups (preferably substituted or unsubstituted carbamoyloxy groups having from 1 to 30 carbon atoms such as N,N-dimethylcarbamoyloxy, N,N-diethylcarbamoyloxy, morpholinocarbonyloxy, N,N-di-n-octylaminocarbonyloxy and N-n-octylcarbamoyloxy), alkoxycarbonyloxy groups (preferably substituted or unsubstituted alkoxycarbonyloxy groups having from 2 to 30 carbon atoms such as methoxycarbonyloxy, ethoxycarbonyloxy, t-butoxycarbonyloxy and n-octylcarbonyloxy), aryloxycarbonyloxy groups (preferably substituted or unsubstituted aryloxycarbonyloxy groups having from 7 to 30 carbon atoms such as phenoxycarbonyloxy, p-methoxyphenoxycarbonyloxy and p-n-hexadecyloxyphenoxycarbonyloxy), amino groups (preferably substituted or unsubstituted alkylamino groups having from 1 to 30 carbon atoms and substituted or unsubstituted anilino groups having from 6 to 30 carbon atoms such as amino, methylamino, dimethylamino, anilino, N-methyl-anilino and diphenylamino), acylamino groups (preferably a formylamino group, substituted or unsubstituted alkylcarbonylamino groups having from 1 to 30 carbon atoms and substituted or unsubstituted arylcarbonylamino groups having from 6 to 30 carbon atoms such as formylamino, acetylamino, pivaloylamino, lauroylamino and benzoylamino), aminocarbonylamino groups (preferably substituted or unsubstituted aminocarbonylamino groups having from 1 to 30 carbon atoms such as carbamoylamino, N,N-dimethylaminocarbonylamino, N,N-diethylaminocarbonylamino and morpholinocarbonylamino), alkoxycarbonylamino groups (preferably substituted or unsubstituted alkoxycarbonylamino groups having from 2 to 30 carbon atoms such as methoxycarbonylamino, ethoxycarbonylamino, t-butoxycarbonylamino, n-octadecyloxycarbonylamino and N-methyl-methoxycarbonylamino). aryloxycarbonylamino groups (preferably substituted or unsubstituted aryloxycarbonylamino groups having from 7 to 30 carbon atoms such as phenoxycarbonylamino, p-chlorophenoxycarbonylamino and m-n-octyloxyphenoxycarbonylamino), sulfamoylamino groups (preferably substituted or unsubstituted sulfamoylamino groups having from 0 to 30 carbon atoms such as sulfamoylamino, N,N-dimethylaminosulfonylamino and N-n-octylaminosulfonylamino), alkyl- and arylsulfonylamino groups (preferably substituted or unsubstituted alkylsulfonylamino groups having from 1 to 30 carbon atoms and substituted or unsubstituted arylsulfonylamino groups having from 6 to 30 carbon atoms such as methylsulfonylamino, butylsulfonylamino, phenylsulfonylamino, 2,3,5-trichlorophenylsulfonylamino and p-methylphenylsulfonylamino), a mercapto group, alkylthio groups (preferably substituted or unsubstituted alkylthio groups having from 1 to 30 carbon atoms such as methylthio, ethylthio and n-hexadecylthio), arylthio groups (preferably substituted or unsubstituted arylthio groups having from 6 to 30 carbon atoms such as phenylthio, p-chlorophenylthio and m-methoxyphenylthio), heterocyclic thio groups (preferably substituted or unsubstituted heterocyclic thio groups having from 2 to 30 carbon atoms such as 2-benzothiazolylthio and 1-phentyltetrazol-5-ylthio), sulfamoyl groups (preferably sulfamoyl groups having from 0 to 30 carbon atoms such as N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl), a sulfo group, alkyl- and arylsulfinyl groups (preferably substituted or unsubstituted alkylsulfinyl group having from 1 to 30 carbon atoms and substituted or unsubstituted arylsulfinyl group having from 6 to 30 carbon atoms such as methylsulfinyl, ethylsulfinyl, phenylsulfinyl and p-methylphenylsulfinyl), alkyl- and arylsulfonyl groups (preferably substituted or unsubstituted alkylsulfonyl groups having from 1 to 30 carbon atoms and substituted or unsubstituted arylsulfonyl groups having from 6 to 30 carbon atoms such as methylsulfonyl, ethylsulfonyl, phenylsulfonyl and p-methylphenylsulfonyl), acyl groups (preferably a formyl group, substituted or unsubstituted alkylcarbonyl groups having from 2 to 30 carbon atoms and substituted or unsubstituted arylcarbonyl groups having from 7 to 30 carbon atoms such as acetyl and pivaloylbenzoyl), aryloxycarbonyl groups (preferably substituted or unsubstituted aryloxycarbonyl groups having from 7 to 30 carbon atoms such as phenoxycarbonyl, o-chlorophenoxycarbonyl, m-nitrophenoxycarbonyl and p-t-butylphenoxycarbonyl), alkoxycarbonyl groups (preferably substituted or unsubstituted alkoxycarbonyl groups having from 2 to 30 carbon atoms such as methoxycarbonyl, ethoxycarbonyl, t-butoxycarbonyl and n-octadecyloxycarbonyl), carbamoyl groups (preferably substituted or unsubstituted carbamoyl having from 1 to 30 carbon atoms such as carbamoyl, N-methylcarbamoyl, N,N-dimethylcarbamoyl, N,N-di-n-octylcarbamoyl and N-(methylsulfonyl)carbamoyl), aryl- and heterocyclic azo groups (preferably substituted or unsubstituted arylazo groups having from 6 to 30 carbon atoms and substituted or unsubstituted heterocyclic azo groups having from 3 to 30 carbon atoms such as phenylazo, p-chlorophenylazo and 5-etylthio-1,3,4-thiadiazol-2-ylaoz), imide groups (preferably N-succinimide and N-phthalimide), phosphino groups (preferably substituted or unsubstituted phosphino groups having from 2 to 30 carbon atoms such as dimethylphosphino, diphenylphosphino and methylphenoxyphosphino), phosphinyl groups (preferably substituted or unsubstituted phosphinyl groups having from 2 to 30 carbon atoms such as phosphinyl, dioetyloxyphosphinyl and diethoxyphosphinyl), phosphinyloxy groups (preferably substituted or unsubstituted phosphinyloxy groups having from 2 to 30 carbon atoms such as diphenoxyphosphinyloxy and dioetyloxyphosphinyloxy), phosphinylamino groups (preferably substituted or unsubstituted phosphinylamino groups having from 2 to 30 carbon atoms such as dimethoxyphosphinylamino and dimethylaminophosphinylamino) and silyl groups (preferably substituted or unsubstituted silyl groups having from 3 to 30 carbon atoms such as trimethylsilyl, t-butyldimethylsilyl and phenyldimethylsilyl).

In the substituents as cited above, those having a hydrogen atom may be further substituted, after removing the hydrogen atom, by a substituent as described above. Examples of such functional groups include alkylcarbonylaminosulfonyl groups, arylcarbonylaminosulfonyl groups, alkylsulfonylaminocarbonyl groups and arylsulfonylaminocarbonyl groups. Examples thereof include methylsulfonylaminocarbonyl, p-methylphenylsulfonylaminocarbonyl, acetylaminosulfonyl and benzoylaminosulfonyl groups.

In the case of having two or more substituents, these substituents may be either the same or different. If possible, these substituents may be bonded together to form a ring.

Next, the compounds represented by the formula (1) and the formula (2) will be described in greater detail by referring to specific examples thereof, though the invention is not restricted to these specific examples.

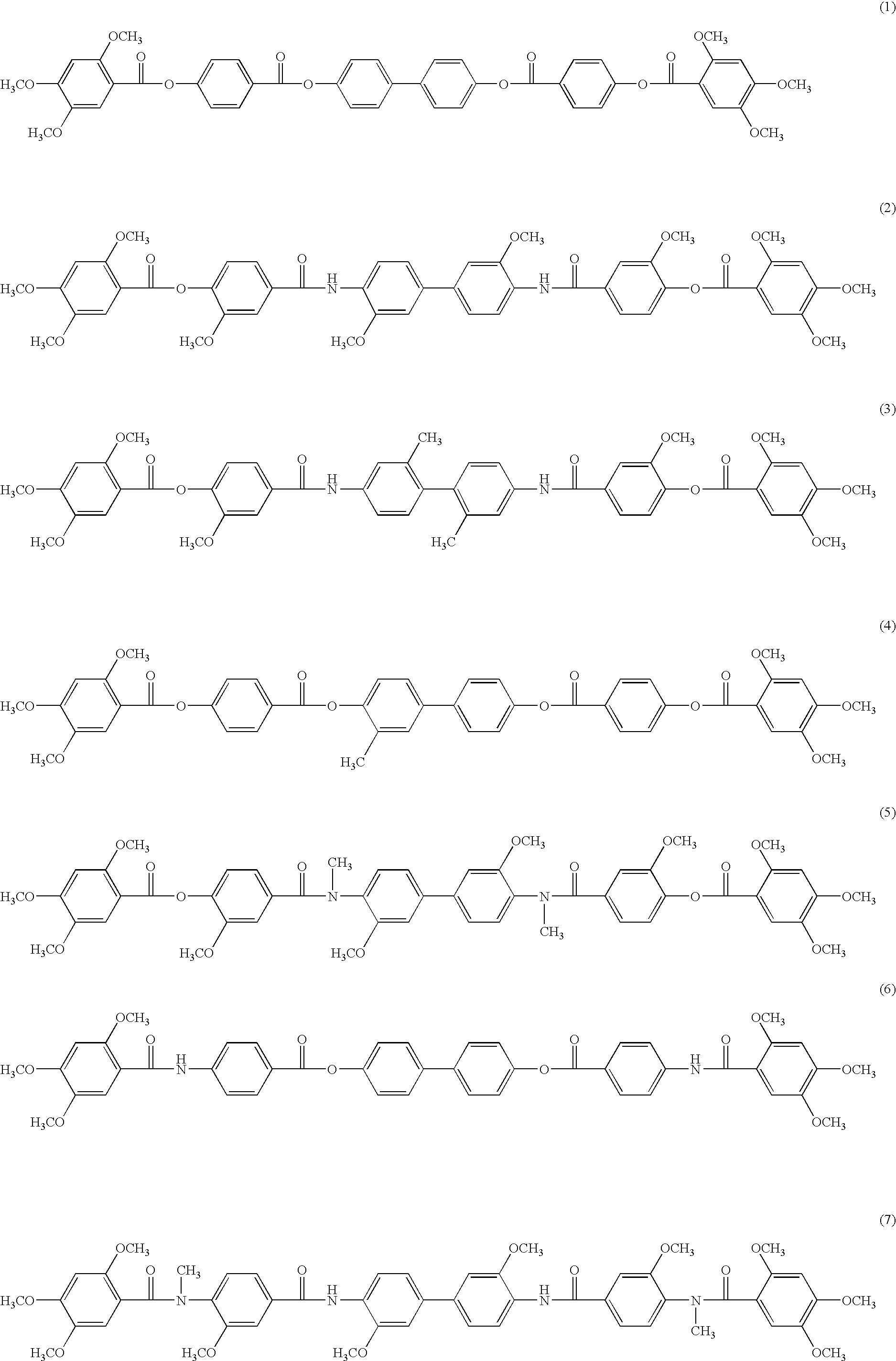

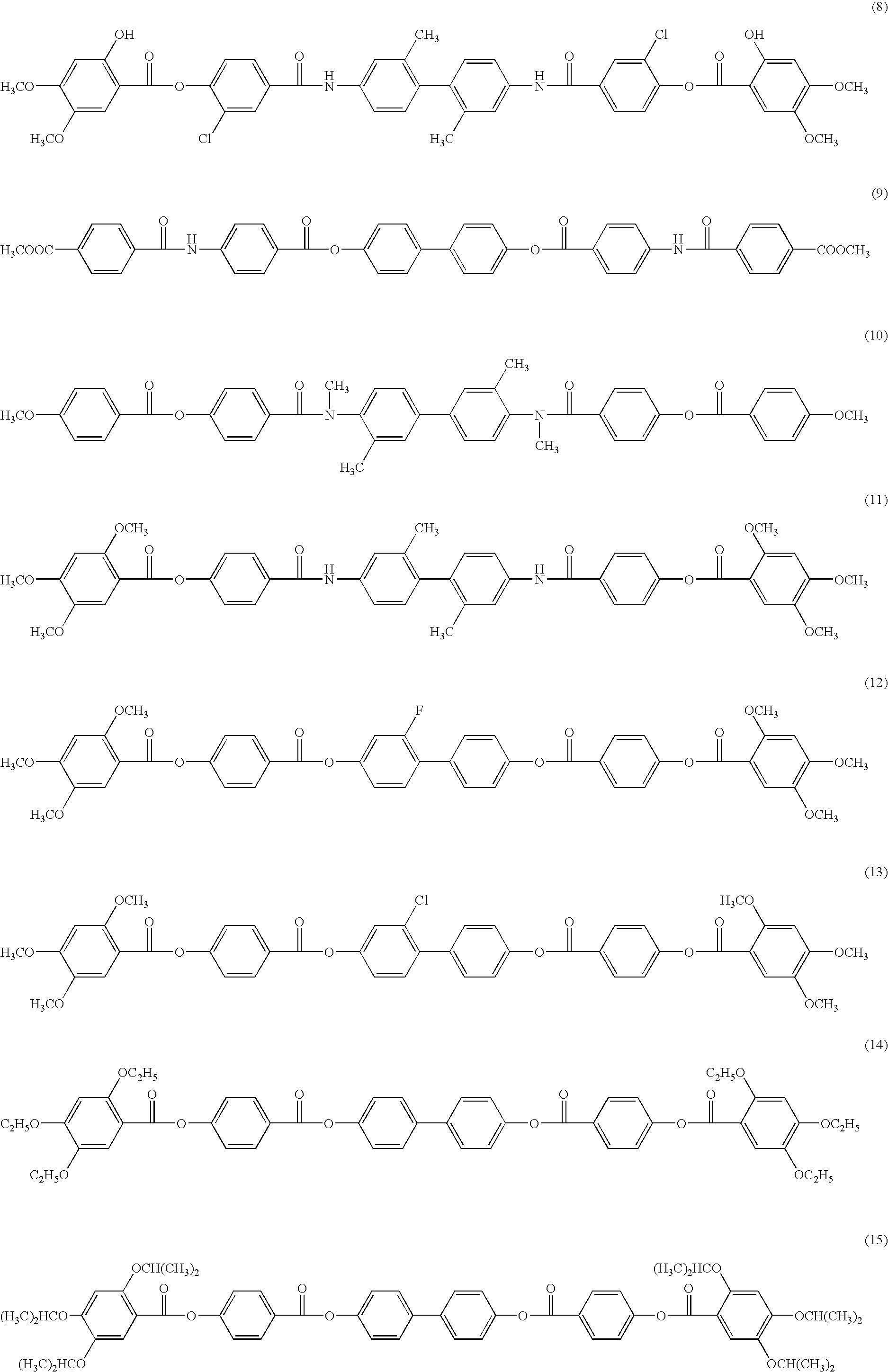

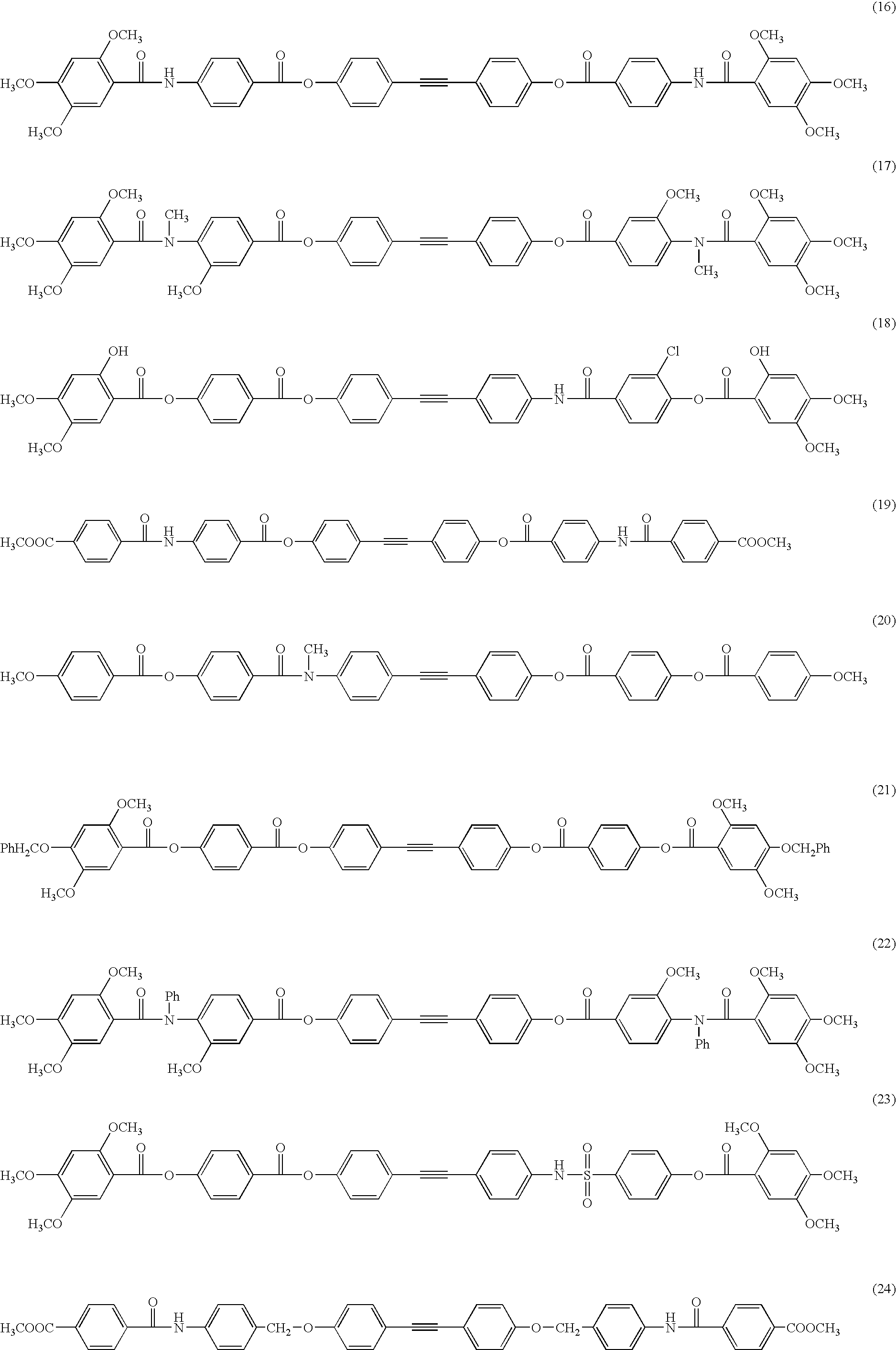

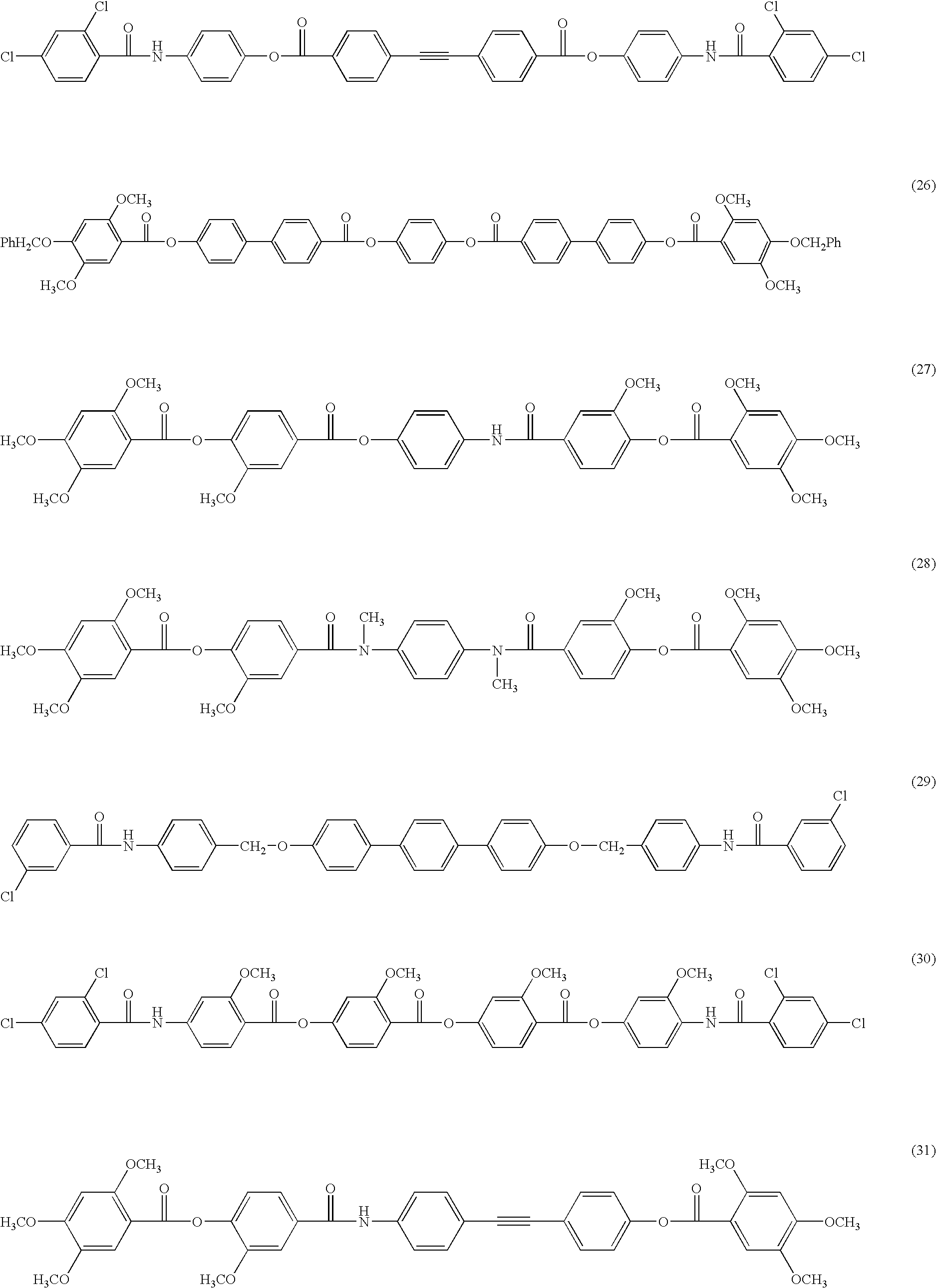

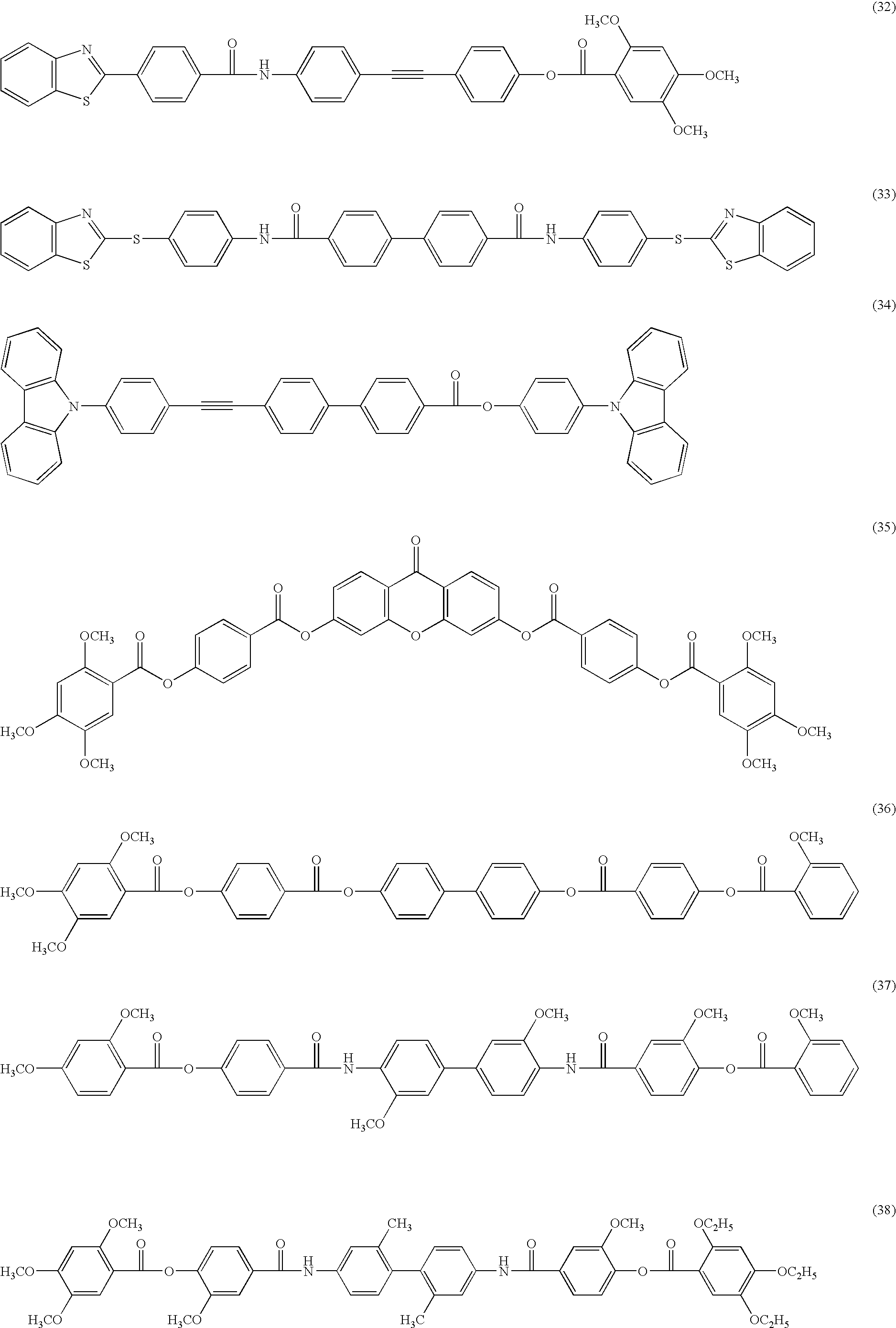

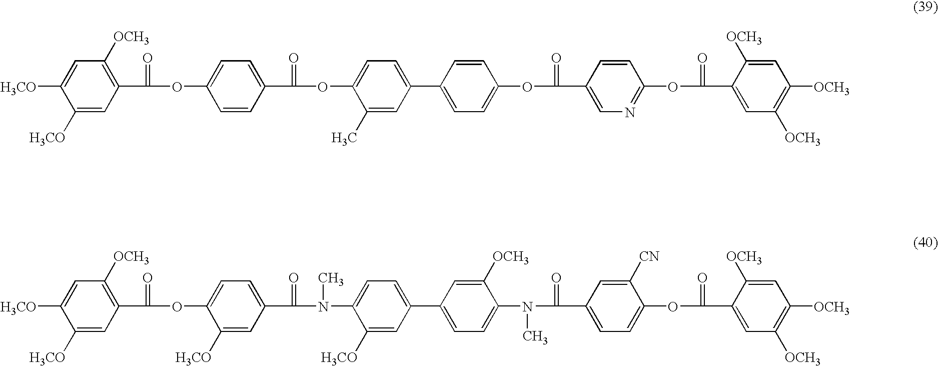

Moreover, a compound represented by the following formula (3) is preferred too.

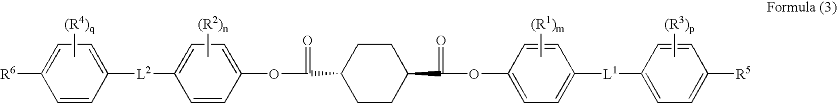

wherein R¹, R², R³, R⁴, R⁵ and R⁶ independently represent each a substituent; L¹ and L² independently represent each a single bond or a divalent linking group; n and m independently represent each an integer of from 0 to 4; and p and q independently represent each an integer of from 0 to 3.

R¹, R², R³, R⁴, R⁵ and R⁶ independently represent each a substituent other than a hydrogen atom. R¹, R², R³, R⁴, R⁵ and R⁶ may be either the same or different. Preferable examples of the substituents include halogen atoms (for example, a fluorine atom, a chlorine atom, a bromine atom and an iodine atom), alkyl groups (preferably alkyl groups having from 1 to 30 carbon atoms such as methyl, ethyl, n-propyl, isopropyl, t-butyl, n-oetyl and 2-ethylhexyl), cycloalkyl groups (preferably substituted or unsubstituted cycloalkyl groups having from 3 to 30 carbon atoms such as cyclohexyl, cyclopentyl and 4-n-dodecylcyclohexyl), bicycloalkyl groups (preferably substituted or unsubstituted bicycloalkyl groups having from 5 to 30 carbon atoms, i.e., monovalent groups remaining after removing a hydrogen atom from bicycloalkanes having from 5 to 30 carbon atoms such as bicyclo[1,2,2]heptan-2-yl, bicyclo[2,2,2]octan-3-yl), alkenyl groups (preferably substituted or unsubstituted alkenyl groups having from 2 to 30 carbon atoms such as vinyl and allyl), cycloalkenyl groups (preferably substituted or unsubstituted cycloalkenyl groups having from 3 to 30 carbon atoms, i.e., monovalent groups remaining after removing a hydrogen atom from cycloalkenes having from 3 to 30 carbon atoms such as 2-cyclopenten-1-yl and 2-cyclohexen-1-yl), bicycloalkenyl groups (substituted or unsubstituted bicycloalkenyl groups, preferably substituted or unsubstituted bicycloalkenyl groups having from 5 to 30 carbon atoms, i.e., monovalent groups remaining after removing a hydrogen atom in bicycloalkenes having one double bond such as bicyclo[2,2,1]hept-2-en-1-yl and bicyclo[2,2,2]oct-2-en-4-yl), alkynyl groups (preferably substituted or unsubstituted alkynyl groups having from 2 to 30 carbon atoms such as ethynyl and propargyl), aryl groups (preferably substituted or unsubstituted aryl groups having from 6 to 30 carbon atoms such as phenyl, p-tolyl and naphthyl), heterocycles (preferably monovalent groups remaining after removing one hydrogen atom from substituted or unsubstituted and aromatic or non-aromatic 5- or 6-membered heterocyclic compounds, more preferably 5- or 6-membered aromatic heterocycles having from 3 to 30 carbon atoms such as 2-furyl, 2-thienyl, 2-pyrimidinyl and 2-benzthiazolyl), a cyano group, a hydroxyl group, a nitro group, a carboxyl group, alkoxy groups (preferably substituted or unsubstituted alkoxy groups having from 1 to 30 carbon atoms such as methoxy, ethoxy, isopropoxy, t-butoxy, n-octyloxy and 2-methoxyethoxy), aryloxy groups (preferably substituted or unsubstituted aryloxy groups having from 6 to 30 carbon atoms such as phenoxy, 2-methylphenoxy, 4-tert-butylphenoxy, 3-nitrophenoxy and 2-tetradecanoylaminophenoxy), silyloxy groups (preferably silyloxy groups having from 3 to 20 carbon atoms such as trimethylsilyloxy and tert-butyldimethylsilyloxy), heterocyclic oxy groups (preferably substituted or unsubstituted heterocyclic oxy groups having from 2 to 30 carbon atoms such as 1-phenyltetrazol-5-oxy and 2-tetrahydropyranyloxy), acyloxy groups (preferably a formyloxy group, substituted or unsubstituted alkylcarbonyloxy groups having from 2 to 30 carbon atoms and substituted or unsubstituted arylcarbonyloxy groups having from 6 to 30 carbon atoms such as formyloxy, acetyloxy, pivaloyloxy, stearoyloxy, benzoyloxy and p-methoxyphenylcarbonyloxy), carbamoyloxy groups (preferably substituted or unsubstituted carbamoyloxy groups having from 1 to 30 carbon atoms such as N,N-dimethylcarbamoyloxy; N,N-diethylcarbamoyloxy, morpholinocarbonyloxy, N,N-di-n-octylaminocarbonyloxy and N-n-octylcarbamoyloxy), alkoxycarbonyloxy groups (preferably substituted or unsubstituted alkoxycarbonyloxy groups having from 2 to 30 carbon atoms such as methoxycarbonyloxy, ethoxycarbonyloxy, tert-butoxycarbonyloxy and n-octylcarbonyloxy), aryloxycarbonyloxy groups (preferably substituted or unsubstituted aryloxycarbonyloxy groups having from 7 to 30 carbon atoms such as phenoxycarbonyloxy, p-methoxyphenoxycarbonyloxy and p-n-hexadecyloxyphenoxycarbonyloxy), amino groups (preferably an amino group, substituted or unsubstituted alkylamino groups having from 1 to 30 carbon atoms and substituted or unsubstituted anilino groups having from 6 to 30 carbon atoms such as amino methylamino, dimethylamino, anilino, N-methyl-anilino and diphenylamino), acylamino groups (preferably a formylamino group, substituted or unsubstituted alkylcarbonylamino groups having from 1 to 30 carbon atoms and substituted or unsubstituted arylcarbonylamino groups having from 6 to 30 carbon atoms such as formylamino, acetylamino, pivaloylamino, lauroylamino and benzoylamino), aminocarbonylamino groups (preferably substituted or unsubstituted aminocarbonylamino groups having from 1 to 30 carbon atoms such as carbamoylamino, N,N-dimethylaminocarbonylamino, N,N-diethylaminocarbonylamino and morpholinocarbonylamino), alkoxycarbonylamino groups (preferably substituted or unsubstituted alkoxycarbonylamino groups having from 2 to 30 carbon atoms such as methoxycarbonylamino, ethoxycarbonylamino, tert-butoxycarbonylamino, n-octadecyloxycarbonylamino and N-methyl-methoxycarbonylamino), aryloxycarbonylamino groups (preferably substituted or unsubstituted aryloxycarbonylamino groups having from 7 to 30 carbon atoms such as phenoxycarbonylamino, p-chlorophenoxycarbonylamino and m-n-octyloxyphenoxycarbonylamino), sulfamoylamino groups (preferably substituted or unsubstituted sulfamoylamino groups having from 0 to 30 carbon atoms such as sulfamoylamino, N,N-dimethylaminosulfonylamino and N-n-octylaminosulfonylamino), alkyl- and arylsulfonylamino groups (preferably substituted or unsubstituted alkylsulfonylamino groups having from 1 to 30 carbon atoms and substituted or unsubstituted arylsulfonylamino groups having from 6 to 30 carbon atoms such as methylsulfonylamino, butylsulfonylamino, phenylsulfonylamino, 2,3,5-trichlorophenylsulfonylamino and p-methylphenylsulfonylamino), a mercapto group, alkylthio groups (preferably substituted or unsubstituted alkylthio groups having from 1 to 30 carbon atoms such as methylthio, ethylthio and n-hexadecylthio), arylthio groups (preferably substituted or unsubstituted arylthio groups having from 6 to 30 carbon atoms such as phenylthio, p-chlorophenylthio and m-methoxyphenylthio), heterocyclic thio groups (preferably substituted or unsubstituted heterocyclic thio groups having from 2 to 30 carbon atoms such as 2-benzothiazolylthio and 1-phentyltetrazol-5-ylthio), sulfamoyl groups (preferably sulfamoyl groups having from 0 to 30 carbon atoms such as N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl), a sulfo group, alkyl- and arylsulfinyl groups (preferably substituted or unsubstituted alkylsulfinyl group having from 1 to 30 carbon atoms and substituted or unsubstituted arylsulfinyl group having from 6 to 30 carbon atoms such as methylsulfinyl, ethylsulfinyl, phenylsulfinyl and p-methylphenylsulfinyl), alkyl- and arylsulfonyl groups (preferably substituted or unsubstituted alkylsulfonyl groups having from 1 to 30 carbon atoms and substituted or unsubstituted arylsulfonyl groups having from 6 to 30 carbon atoms such as methylsulfonyl, ethylsulfonyl, phenylsulfonyl and p-methylphenylsulfonyl), acyl groups (preferably a formyl group, substituted or unsubstituted alkylcarbonyl groups having from 2 to 30 carbon atoms and substituted or unsubstituted arylcarbonyl groups having from 7 to 30 carbon atoms such as acetyl and pivaloylbenzoyl), aryloxycarbonyl groups (preferably substituted or unsubstituted aryloxycarbonyl groups having from 7 to 30 carbon atoms such as phenoxycarbonyl, o-chlorophenoxycarbonyl, m-nitrophenoxycarbonyl and p-tert-butylphenoxycarbonyl), alkoxycarbonyl groups (preferably substituted or unsubstituted alkoxycarbonyl groups having from 2 to 30 carbon atoms such as methoxycarbonyl, ethoxycarbonyl, tert-butoxycarbonyl and n-octadecyloxycarbonyl), carbamoyl groups (preferably substituted or unsubstituted carbamoyl having from 1 to 30 carbon atoms such as carbamoyl, N-methylcarbamoyl, N,N-dimethylcarbamoyl, N,N-di-n-octylcarbamoyl and N-(methylsulfonyl)carbamoyl), aryl- and heterocyclic azo groups (preferably substituted or unsubstituted arylazo groups having from 6 to 30 carbon atoms and substituted or unsubstituted heterocyclic azo groups having from 3 to 30 carbon atoms such as phenylazo, p-chlorophenylazo and 5-etylthio-1,3,4-thiadiazol-2-ylaoz), imide groups (preferably N-succinimide and N-phthalimide), phosphino groups (preferably substituted or unsubstituted phosphino groups having from 2 to 30 carbon atoms such as dimethylphosphino, diphenylphosphino and methylphenoxyphosphino), phosphinyl groups (preferably substituted or unsubstituted phosphinyl groups having from 2 to 30 carbon atoms such as phosphinyl, dioctyloxyphosphinyl and diethoxyphosphinyl), phosphinyloxy groups (preferably substituted or unsubstituted phosphinyloxy groups having from 2 to 30 carbon atoms such as diphenoxyphosphinyloxy and dioctyloxyphosphinyloxy), phosphinylamino groups (preferably substituted or unsubstituted phosphinylamino groups having from 2 to 30 carbon atoms such as dimethoxyphosphinylamino and dimethylaminophosphinylamino) and silyl groups (preferably substituted or unsubstituted silyl groups having from 3 to 30 carbon atoms such as trimethylsilyl, tert-butyldimethylsilyl and phenyldimethylsilyl).

In the substituents as cited above, those having a hydrogen atom may be further substituted, after removing the hydrogen atom, by a substituent as described above. Examples of such functional groups include alkylcarbonylaminosulfonyl groups, arylcarbonylaminosulfonyl groups, alkylsulfonylaminocarbonyl groups and arylsulfonylaminocarbonyl groups. Examples thereof include methylsulfonylaminocarbonyl, p-methylphenylsulfonylaminocarbonyl, acetylaminosulfonyl and benzoylaminosulfonyl groups.

Among all, preferable examples of the substituents include alkyl groups, alkoxy groups, alkoxycarbonyl groups, acyl groups, alkoxycarbonyloxy groups, cycloalkyl groups, acylamino groups, cyano group and halogen atoms.

In the case of having two or more substituents, these substituents may be either the same or different. If possible these substituents may be bonded together to form a ring.

In the formula (3), L¹ and L² represent each a single bond or a divalent linking group. L¹ and L² may be either the same or different. Preferable example of the divalent linking group include a group represented by —NR⁷— (wherein R⁷ represents a hydrogen atom or an alkyl group or an aryl group which may have a substituent), —SO₂—, —CO—, an alkylene group, a substituted alkylene group, an alkenylene group, a substituted alkenylene group, an alkynylene group, —O—, —S—, —SO— and a group obtained by combining two or more of these divalent groups. Among them, —O—, —CO—, —SO₂NR⁷—, —NR⁷SO₂—, —CONR⁷—, —NR⁷CO—, —COO—, —OCO— and an alkynylene group are more preferable. As the substituent, the examples cited as the substituents R¹, R², R³, R⁴, R⁵ and R⁶ are applicable.

n and m independently represent each an integer of from 0 to 4. In the case where m and n are each 2 or more, R¹s and R²s in the repeating unit may be either the same or different. p and q independently represent each an integer of from 0 to 3. In the case where p and q are each 2 or more, R³s and R⁴s in the repeating unit may be either the same or different. Furthermore, R³ and R⁵, and R⁴ and R⁶ may be bonded together to form each a ring. From the viewpoint of controlling retardation, it is preferred that the compound represented by the formula (1) is a symmetric compound (i.e., the groups attached to the 1- and 4-position of cyclohexane located at the center in the formula (3) have the same structures).

Next, the compounds represented by the formula (3) will be described in greater detail by referring to specific examples thereof, though the invention is not restricted to these specific examples.

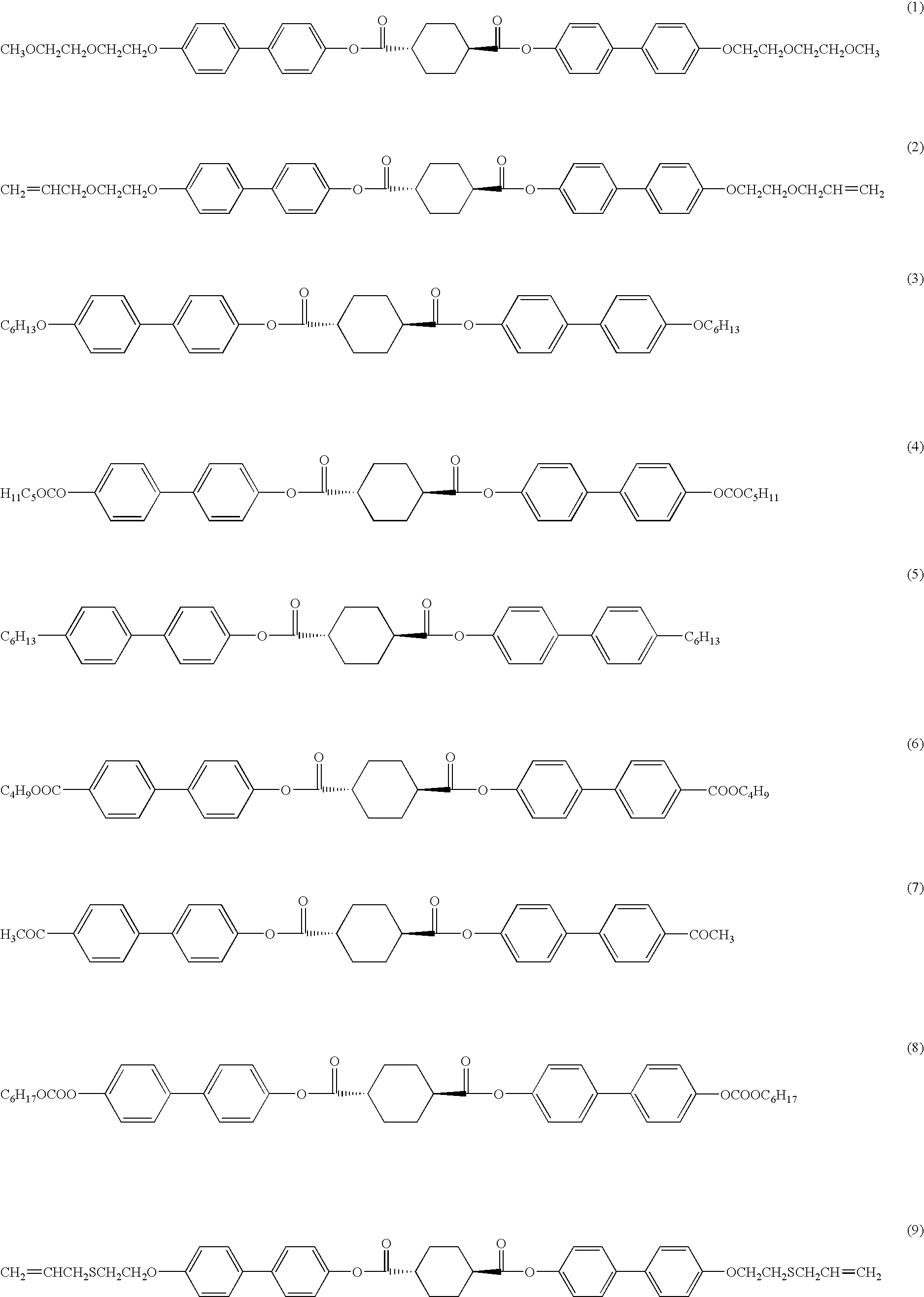

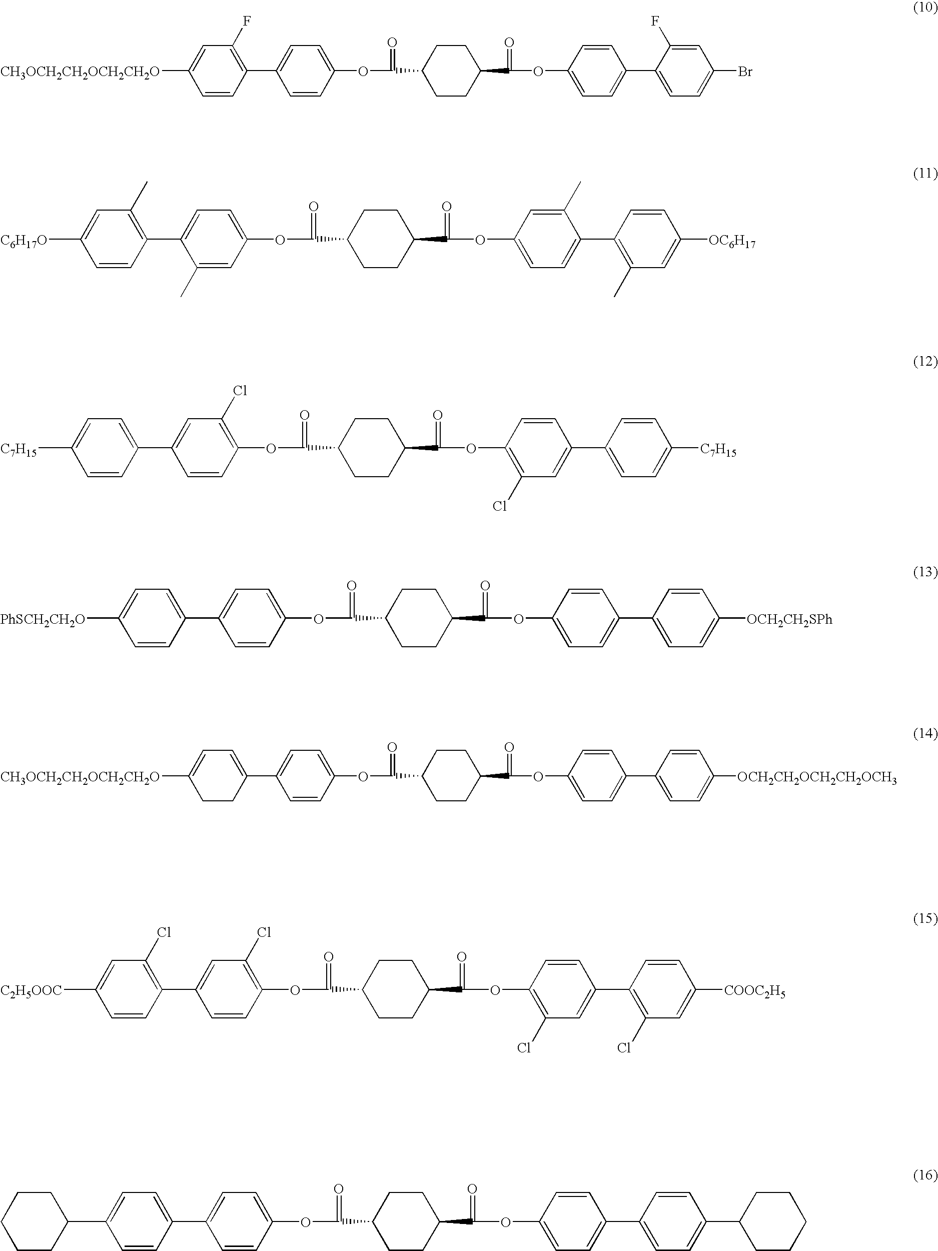

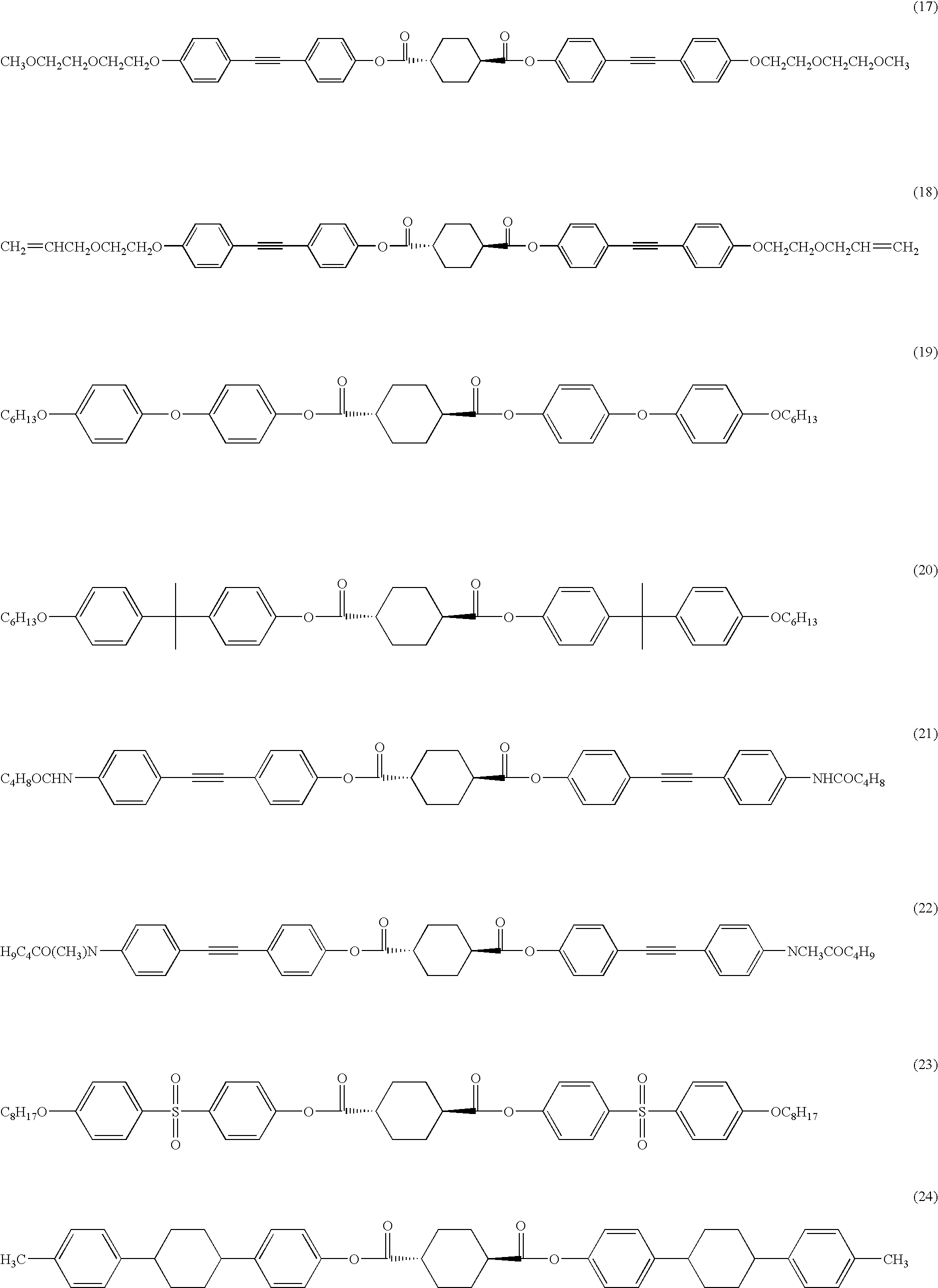

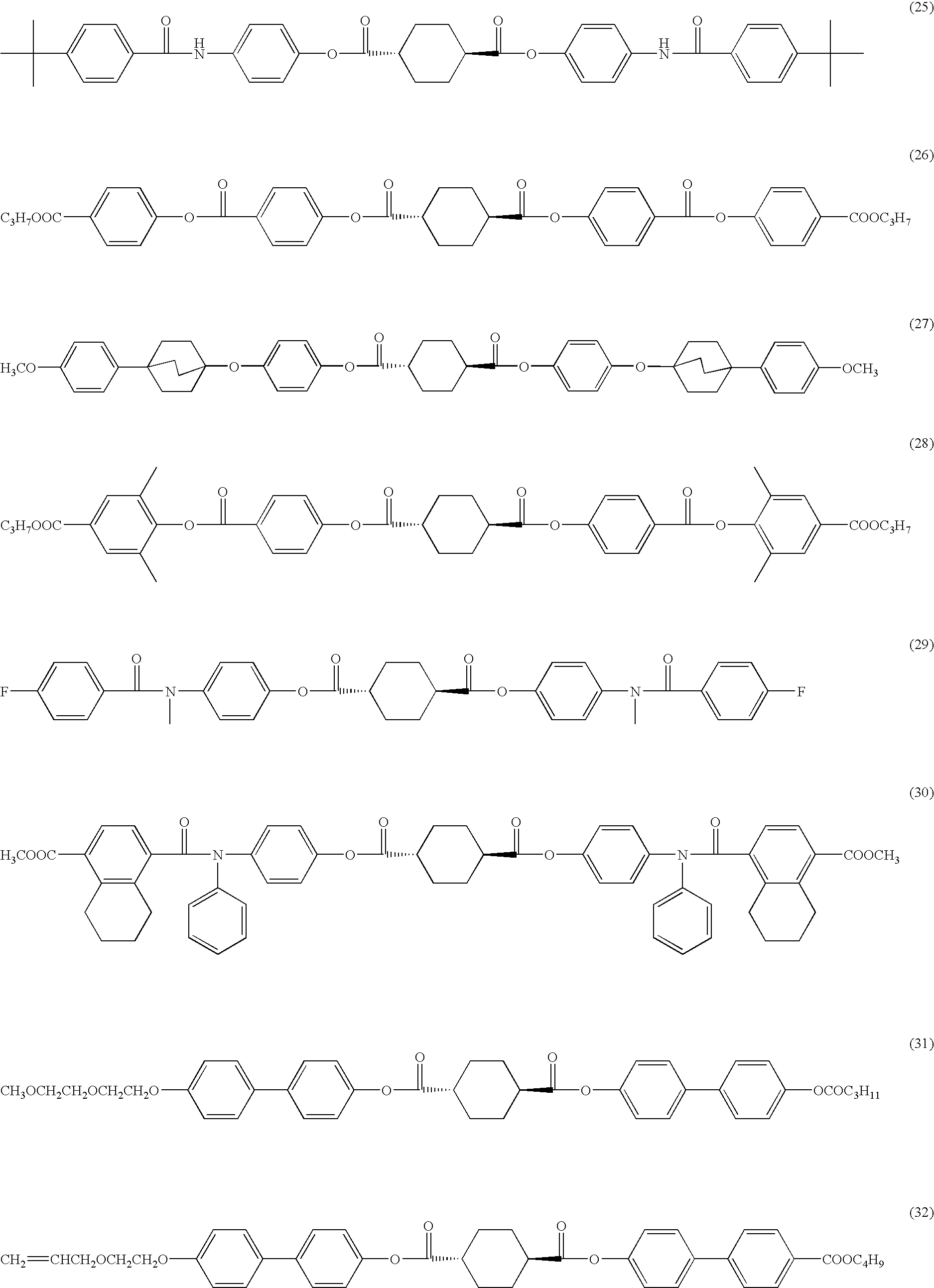

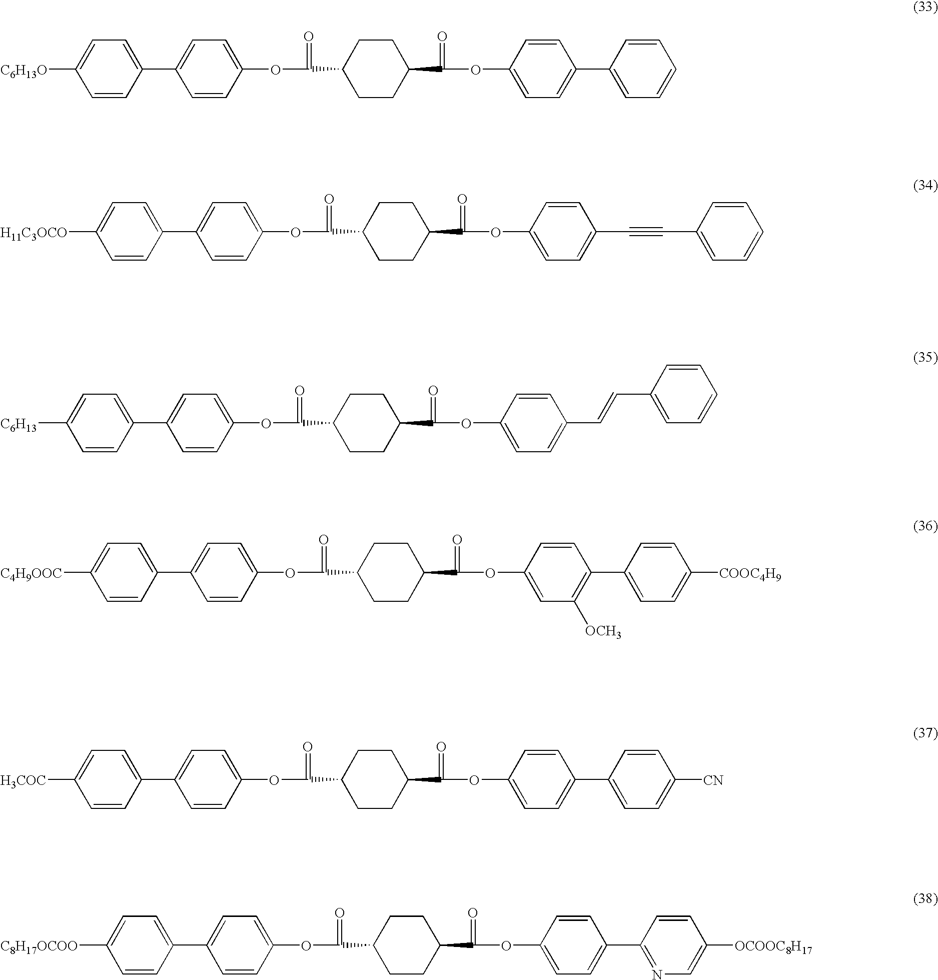

Moreover, a compound represented by the following formula (4) is preferred too.

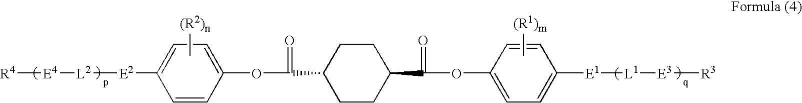

wherein R¹, R², R³ and R⁴ independently represent each a substituent; E¹, E², E³ and E⁴ independently represent each an oxygen atom or a sulfur atom; L¹ and L² independently represent each a divalent linking group; n and m independently represent each an integer of from 0 to 4; and p and q independently represent each an integer of from 1 to 10.

R¹ and R² independently represent each a substituent. Preferable examples of the substituents include halogen atoms (for example, a fluorine atom, a chlorine atom, a bromine atom and an iodine atom), alkyl groups (preferably alkyl groups having from 1 to 30 carbon atoms such as methyl, ethyl, n-propyl, isopropyl, t-butyl, n-octyl and 2-ethylhexyl), cycloalkyl groups (preferably substituted or unsubstituted cycloalkyl groups having from 3 to 30 carbon atoms such as cyclohexyl, cyclopentyl and 4-n-dodecylcyclohexyl), bicycloalkyl groups (preferably substituted or unsubstituted bicycloalkyl groups having from 5 to 30 carbon atoms, i.e., monovalent groups remaining after removing a hydrogen atom from bicycloalkanes having from 5 to 30 carbon atoms such as bicyclo[1,2,2]heptan-2-yl, bicyclo[2,2,2]octan-3-yl), alkenyl groups (preferably substituted or unsubstituted alkenyl groups having from 2 to 30 carbon atoms such as vinyl and allyl), cycloalkenyl groups (preferably substituted or unsubstituted cycloalkenyl groups having from 3 to 30 carbon atoms, i.e., monovalent groups remaining after removing a hydrogen atom from cycloalkenes having from 3 to 30 carbon atoms such as 2-cyclopenten-1-yl and 2-cyclohexen-1-yl), bicycloalkenyl groups (substituted or unsubstituted bicycloalkenyl groups, preferably substituted or unsubstituted bicycloalkenyl groups having from 5 to 30 carbon atoms, i.e., monovalent groups remaining after removing a hydrogen atom in bicycloalkenes having one double bond such as bicyclo[2,2,1]hept-2-en-1-yl and bicyclo[2,2,2]oct-2-en-4-yl), alkynyl groups (preferably substituted or unsubstituted alkynyl groups having from 2 to 30 carbon atoms such as ethynyl and propargyl), aryl groups (preferably substituted or unsubstituted aryl groups having from 6 to 30 carbon atoms such as phenyl, p-tolyl and naphthyl), heterocycles (preferably monovalent groups remaining after removing one hydrogen atom from substituted or unsubstituted and aromatic or non-aromatic 5- or 6-membered heterocyclic compounds, more preferably 5- or 6-membered aromatic heterocycles having from 3 to 30 carbon atoms such as 2-furyl, 2-thienyl, 2-pyrimidinyl and 2-benzthiazolyl), a cyano group, a hydroxyl group, a nitro group, a carboxyl group, alkoxy groups (preferably substituted or unsubstituted alkoxy groups having from 1 to 30 carbon atoms such as methoxy, ethoxy, isopropoxy, t-butoxy, n-octyloxy and 2-methoxyethoxy), aryloxy groups (preferably substituted or unsubstituted aryloxy groups having from 6 to 30 carbon atoms such as phenoxy, 2-methylphenoxy, 4-tert-butylphenoxy, 3-nitrophenoxy and 2-tetradecanoylaminophenoxy), silyloxy groups (preferably silyloxy groups having from 3 to 20 carbon atoms such as trimethylsilyloxy and tert-butyldimethylsilyloxy), heterocyclic oxy groups (preferably substituted or unsubstituted heterocyclic oxy groups having from 2 to 30 carbon atoms such as 1-phenyltetrazol-5-oxy and 2-tetrahydropyranyloxy), acyloxy groups (preferably a formyloxy group, substituted or unsubstituted alkylcarbonyloxy groups having from 2 to 30 carbon atoms and substituted or unsubstituted arylcarbonyloxy groups having from 6 to 30 carbon atoms such as formyloxy, acetyloxy, pivaloyloxy, stearoyloxy, benzoyloxy and p-methoxyphenylcarbonyloxy), carbamoyloxy groups (preferably substituted or unsubstituted carbamoyloxy groups having from 1 to 30 carbon atoms such as N,N-dimethylcarbamoyloxy, N,N-diethylcarbamoyloxy, morpholinocarbonyloxy, N,N-di-n-octylaminocarbonyloxy and N-n-octylcarbamoyloxy), alkoxycarbonyloxy groups (preferably substituted or unsubstituted alkoxycarbonyloxy groups having from 2 to 30 carbon atoms such as methoxycarbonyloxy, ethoxycarbonyloxy, tert-butoxycarbonyloxy and n-octylcarbonyloxy), aryloxycarbonyloxy groups (preferably substituted or unsubstituted aryloxycarbonyloxy groups having from 7 to 30 carbon atoms such as phenoxycarbonyloxy, p-methoxyphenoxycarbonyloxy and p-n-hexadecyloxyphenoxycarbonyloxy), amino groups (preferably an amino group, substituted or unsubstituted alkylamino groups having from 1 to 30 carbon atoms and substituted or unsubstituted anilino groups having from 6 to 30 carbon atoms such as amino, methylamino, dimethylamino, anilino, N-methyl-anilino and diphenylamino), acylamino groups (preferably a formylamino group, substituted or unsubstituted alkylcarbonylamino groups having from 1 to 30 carbon atoms and substituted or unsubstituted arylcarbonylamino groups having from 6 to 30 carbon atoms such as formylamino, acetylamino, pivaloylamino, lauroylamino and benzoylamino), aminocarbonylamino groups (preferably substituted or unsubstituted aminocarbonylamino groups having from 1 to 30 carbon atoms such as carbamoylamino, N,N-dimethylaminocarbonylamino, N,N-diethylaminocarbonylamino and morpholinocarbonylamino), alkoxycarbonylamino groups (preferably substituted or unsubstituted alkoxycarbonylamino groups having from 2 to 30 carbon atoms such as methoxycarbonylamino, ethoxycarbonylamino, tert-butoxycarbonylamino, n-octadecyloxycarbonylamino and N-methyl-methoxycarbonylamino), aryloxycarbonylamino groups (preferably substituted or unsubstituted aryloxycarbonylamino groups having from 7 to 30 carbon atoms such as phenoxycarbonylamino, p-chlorophenoxycarbonylamino and m-n-octyloxyphenoxycarbonylamino), sulfamoylamino groups (preferably substituted or unsubstituted sulfamoylamino groups having from 0 to 30 carbon atoms such as sulfamoylamino, N,N-dimethylaminosulfonylamino and N-n-octylaminosulfonylamino), alkyl- and arylsulfonylamino groups (preferably substituted or unsubstituted alkylsulfonylamino groups having from 1 to 30 carbon atoms and substituted or unsubstituted arylsulfonylamino groups having from 6 to 30 carbon atoms such as methylsulfonylamino, butylsulfonylamino, phenylsulfonylamino, 2,3,5-trichlorophenylsulfonylamino and p-methylphenylsulfonylamino), a mercapto group, alkylthio groups (preferably substituted or unsubstituted alkylthio groups having from 1 to 30 carbon atoms such as methylthio, ethylthio and n-hexadecylthio), arylthio groups (preferably substituted or unsubstituted arylthio groups having from 6 to 30 carbon atoms such as phenylthio, p-chlorophenylthio and m-methoxyphenylthio), heterocyclic thio groups (preferably substituted or unsubstituted heterocyclic thio groups having from 2 to 30 carbon atoms such as 2-benzothiazolylthio and 1-phentyltetrazol-5-ylthio), sulfamoyl groups (preferably sulfamoyl groups having from 0 to 30 carbon atoms such as N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl), a sulfo group, alkyl- and arylsulfinyl groups (preferably substituted or unsubstituted alkylsulfinyl group having from 1 to 30 carbon atoms and substituted or unsubstituted arylsulfinyl group having from 6 to 30 carbon atoms such as methylsulfinyl, ethylsulfinyl, phenylsulfinyl and p-methylphenylsulfinyl), alkyl- and arylsulfonyl groups (preferably substituted or unsubstituted alkylsulfonyl groups having from 1 to 30 carbon atoms and substituted or unsubstituted arylsulfonyl groups having from 6 to 30 carbon atoms such as methylsulfonyl, ethylsulfonyl, phenylsulfonyl and p-methylphenylsulfonyl), acyl groups (preferably a formyl group, substituted or unsubstituted alkylcarbonyl groups having from 2 to 30 carbon atoms and substituted or unsubstituted arylcarbonyl groups having from 7 to 30 carbon atoms such as acetyl and pivaloylbenzoyl), aryloxycarbonyl groups (preferably substituted or unsubstituted aryloxycarbonyl groups having from 7 to 30 carbon atoms such as phenoxycarbonyl, o-chlorophenoxycarbonyl, m-nitrophenoxycarbonyl and p-tert-butylphenoxycarbonyl), alkoxycarbonyl groups (preferably substituted or unsubstituted alkoxycarbonyl groups having from 2 to 30 carbon atoms such as methoxycarbonyl, ethoxycarbonyl, tert-butoxycarbonyl and n-octadecyloxycarbonyl), carbamoyl groups (preferably substituted or unsubstituted carbamoyl having from 1 to 30 carbon atoms such as carbamoyl, N-methylcarbamoyl, N,N-dimethylcarbamoyl, N,N-di-n-octylcarbamoyl and N-(methylsulfonyl)carbamoyl), aryl- and heterocyclic azo groups (preferably substituted or unsubstituted arylazo groups having from 6 to 30 carbon atoms and substituted or unsubstituted heterocyclic azo groups having from 3 to 30 carbon atoms such as phenylazo, p-chlorophenylazo and 5-etylthio-1,3,4-thiadiazol-2-ylaoz), imide groups (preferably N-succinimide and N-phthalimide), phosphino groups (preferably substituted or unsubstituted phosphino groups having from 2 to 30 carbon atoms such as dimethylphosphino, diphenylphosphino and methylphenoxyphosphino), phosphinyl groups (preferably substituted or unsubstituted phosphinyl groups having from 2 to 30 carbon atoms such as phosphinyl, dioctyloxyphosphinyl and diethoxyphosphinyl), phosphinyloxy groups (preferably substituted or unsubstituted phosphinyloxy groups having from 2 to 30 carbon atoms such as diphenoxyphosphinyloxy and dioctyloxyphosphinyloxy), phosphinylamino groups (preferably substituted or unsubstituted phosphinylamino groups having from 2 to 30 carbon atoms such as dimethoxyphosphinylamino and dimethylaminophosphinylamino) and silyl groups (preferably substituted or unsubstituted silyl groups having from 3 to 30 carbon atoms such as trimethylsilyl, tert-butyldimethylsilyl and phenyldimethylsilyl).

In the substituents as cited above, those having a hydrogen atom may be further substituted, after removing the hydrogen atom, by a substituent as described above. Examples of such functional groups include alkylcarbonylaminosulfonyl groups, arylcarbonylaminosulfonyl groups, alkylsulfonylaminocarbonyl groups and arylsulfonylaminocarbonyl groups. Examples thereof include methylsulfonylaminocarbonyl, p-methylphenylsulfonylaminocarbonyl, acetyl aminosulfonyl and benzoylaminosulfonyl groups.

In the case of having two or more substituents, these substituents may be either the same or different. If possible, these substituents may be bonded together to form a ring.

R³ and R⁴ independently represent each a substituent. Preferable examples of the substituents are the same as those cited above concerning R¹ and R². Among all, particularly preferable examples of the substituents include alkyl groups, cycloalkyl groups, bicycloalkyl groups, alkenyl groups, cycloalkenyl groups, bicycloalkenyl groups, alkynyl groups, aryl groups, heterocycles, sulfamoyl groups, alkyl- and arylsulfonyl groups, acyl groups, aryloxycarbonyl groups, alkoxycarbonyl groups and a carbamoyl groups. Still preferable examples of the substituents include alkyl groups, cycloalkyl groups, alkenyl groups, aryl groups, acyl groups, aryloxycarbonyl groups, alkoxycarbonyl groups and a carbamoyl groups.

L¹ and L² represent each a divalent linking group. L¹ and L² may be either the same or different.

The divalent linking groups are divalent linking groups other than arylene groups. Preferable example thereof include an alkylene group, a substituted alkylene group, an alkenylene group, a substituted alkenylene group, an alkynylene group and a group obtained by combining two or more of these divalent groups. In the case of a divalent group consisting of two or more groups, these groups may be further bonded via another divalent linking group. Examples of the divalent linking group include a group represented by —NR⁷— (wherein R⁷ represents a hydrogen atom or an alkyl group or an aryl group which may have a substituent), —O—, —S—, —SO—, —SO₂—, —CO—, —SO₂NR⁷—, —NR⁷SO₂—, —CONR⁷—, —NR⁷CO—, —COO— and —OCO—. As the substituent, the examples cited as the substituents R¹, R², R³, R⁴, R⁵ and R⁶ are applicable.

n and m independently represent each an integer of from 0 to 4. In the case where m and n are each 2 or more, R¹s and R²s in the repeating unit may be either the same or different. p and q independently represent each an integer of from 1 to 10. In the case where p and q are each 2 or more, E³s and E⁴s and L¹s and L²s in the repeating unit may be either the same or different. From the viewpoint of controlling retardation, it is preferred that the compound represented by the formula (4) is a symmetric compound or an almost symmetric compound (i.e., the groups attached to the 1- and 4-position of cyclohexane located at the center in the formula (1) have the same or closely similar structures).

Next, the compounds represented by the formula (4) will be described in greater detail by referring to specific examples thereof, though the invention is not restricted to these specific examples.

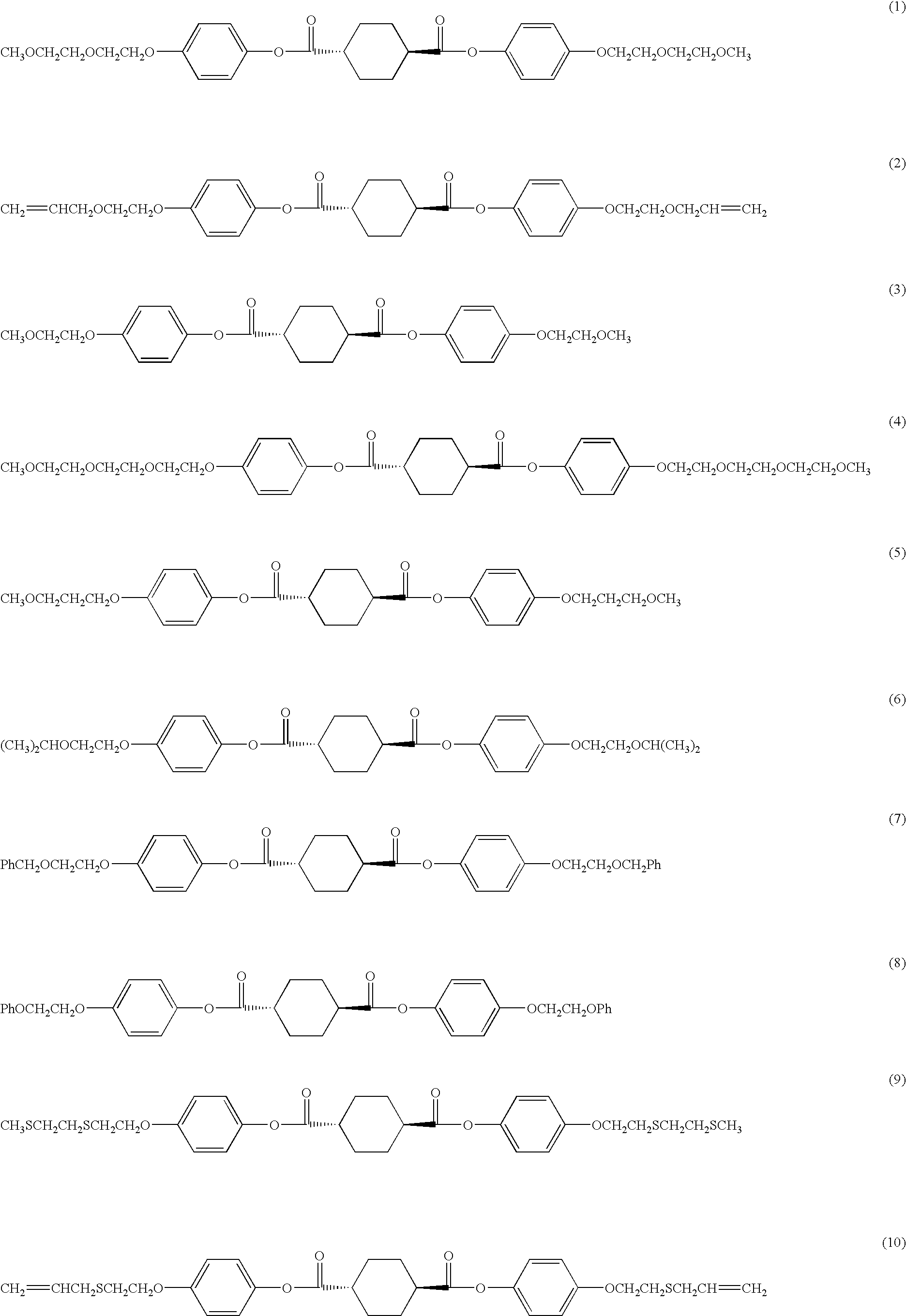

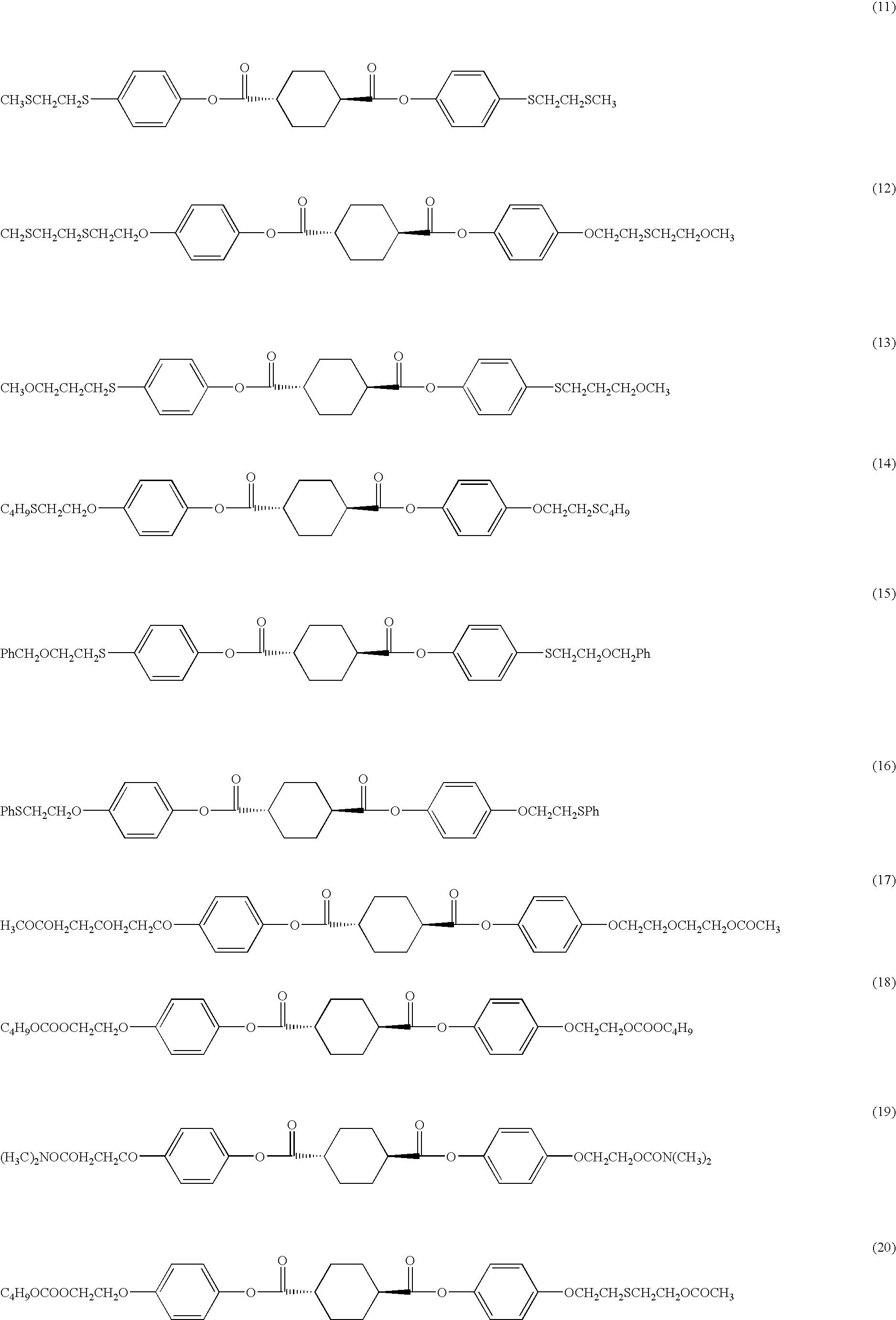

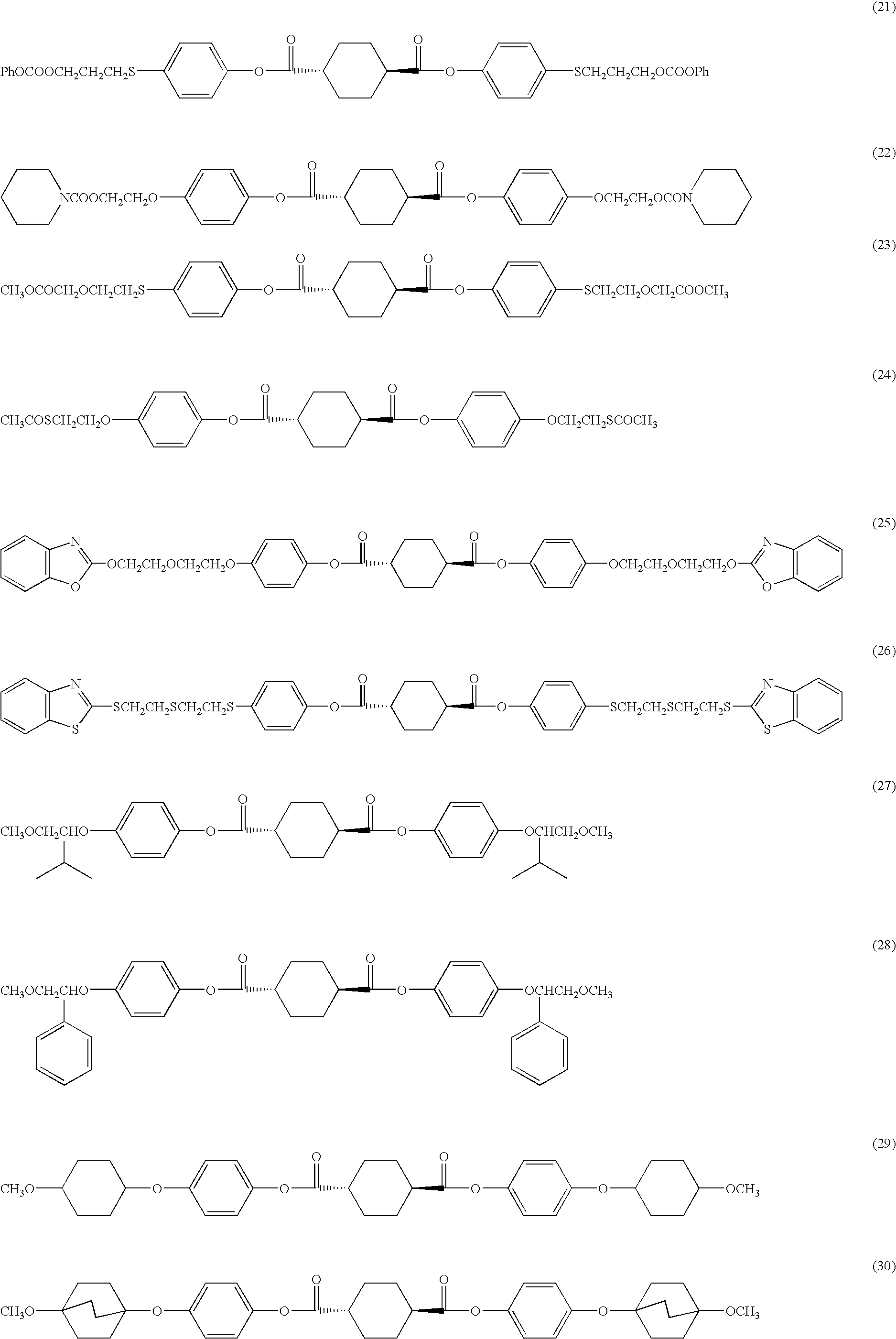

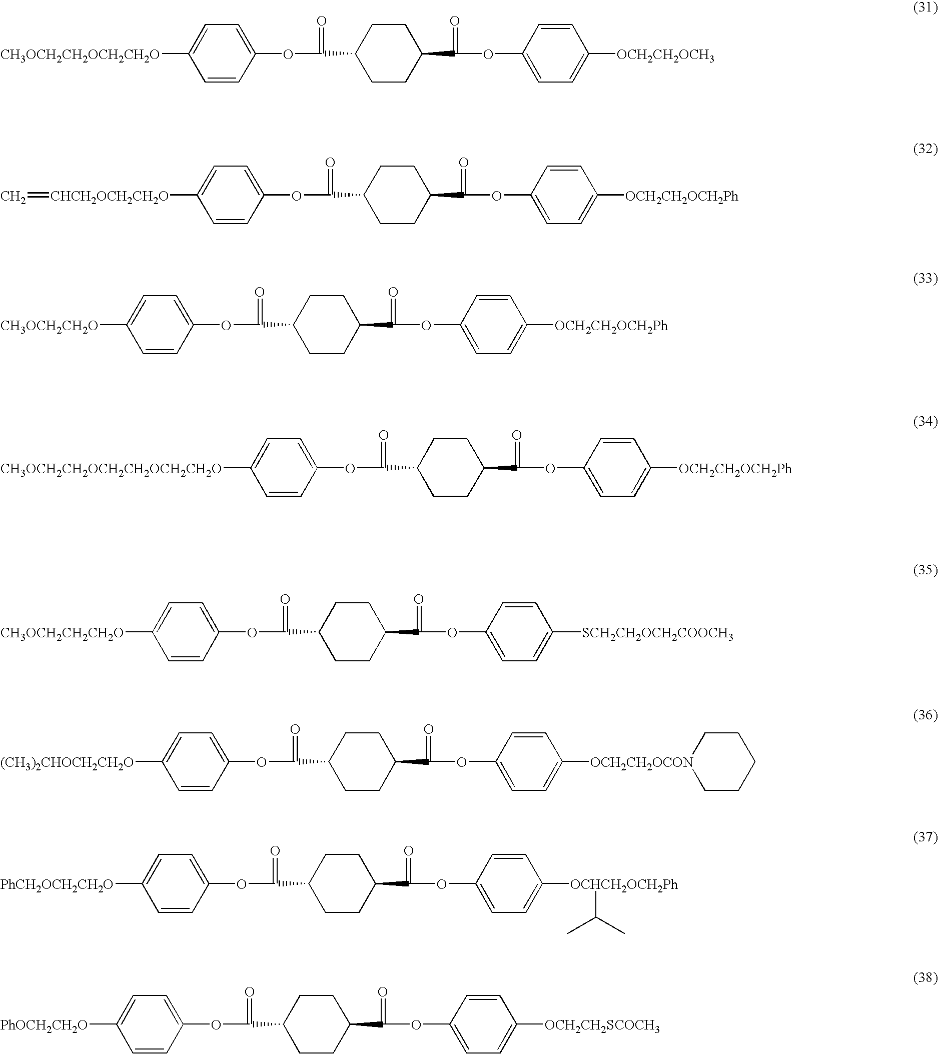

As the liquid crystalline compound of the invention with an aim for controlling a retardation in thickness-direction, triphenylene compounds represented by following formula (5) can be further used preferably.

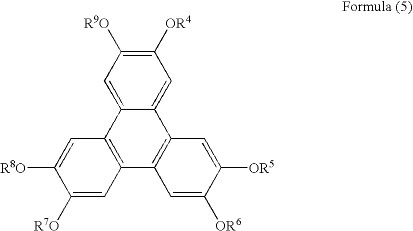

In the formula (5), R⁴, R⁵, R⁶, R⁷, R⁸ and R⁹ each independently represents a hydrogen atom or a substituent. Hereafter, compounds represented by formula (5) will be described. As examples of the substituent represented by each of R⁴, R⁵, R⁶, R⁷, R⁸ and R⁹, the same examples as the examples of R¹ and R² in the formula (4) can be exemplified. As R⁴, R⁵, R⁶, R⁷, R⁸ and R⁹, it is preferably an alkyl group, an aryl group, a substituted or unsubstituted amino group, an alkoxy group, an alkylthio group or a halogen atom. Hereafter, specific examples of the compounds represented by formula (5) will be exemplified, but not limited thereto.

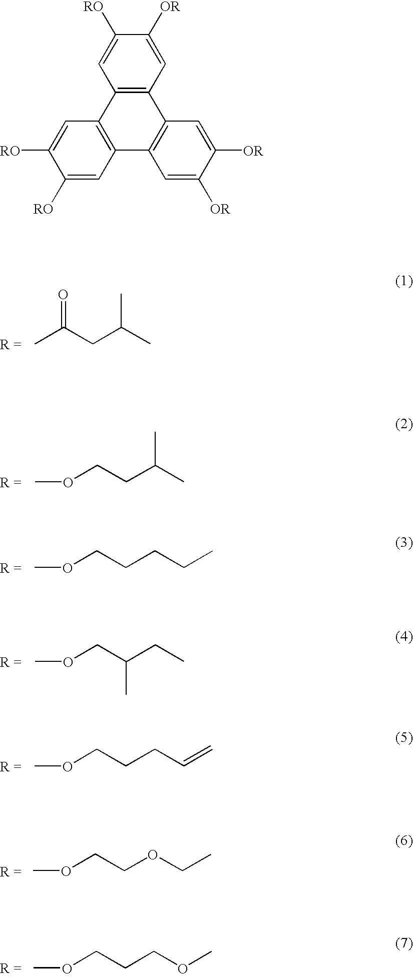

The compounds represented by formula (5) can be synthesized by known methods such as a method described in JP-A-2005-134884.

(Haze)

The measurement of the haze is carried out at 25° C. and 60% RH with respect to a polymer film sample (40 mm×80 mm) by using a haze meter (HGM-2DP, manufactured by Suga Test Instruments Co., Ltd.) according to JIS K-6714. It is preferable that the polymer film of the invention is transparent, i.e., having a low haze. Namely, the haze is preferably 0.1% or more but not more than 1.5%, more preferably 0.1% or more but not more than 1.0% and more preferably 0.1% or more but not more than 0.8%.

As discussed above, the haze can be lowered by using a compound having a dielectric constant ε of 4.0 or more and controlling the size of liquid crystalline compound aggregates. Also, the haze can be determined depending on the refractive index of the liquid crystalline compound, the refractive indexes of an additive and the polymer and so on.

[Light Leakage]

Measurement of light leakage serves as an indication relating to the contrast of a liquid crystal display device. In black display in the state of light is to be blocked, light should be blocked even in the case of inserting a polymer film between two polarizing plates in the crossed Nicols configuration. In an existing polymer film such as an optically compensatory film, the polarization state is changed to cause light leakage which should be avoided inherently. As a result, the luminance is increased in black display and the contrast is lowered. The inventor assumes that these undesirable effects of optical unevenness of a polymer film on its polarization characteristics might cause lowering in contrast. However, it is found out that this phenomenon can be solved by using the polymer film of the invention, though the reason therefor still remains unclear.

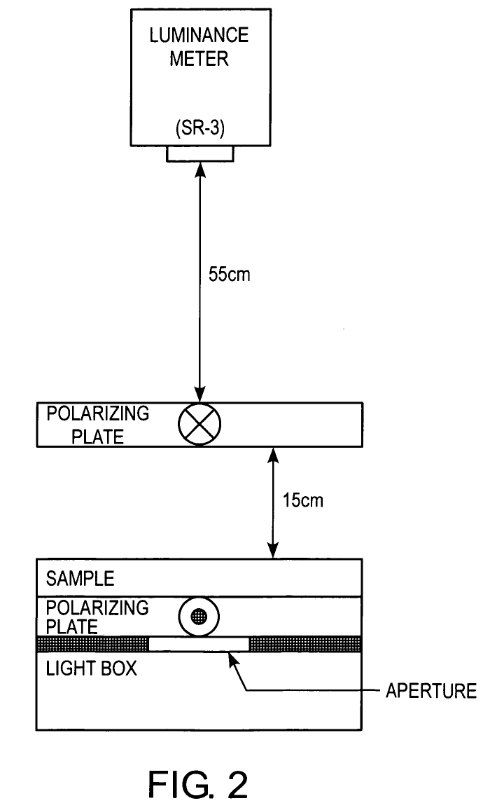

FIG. 2 is a drawing which shows a method of measuring light leakage in the invention. Using a light box generating scattering light as well as backlight as a light source, the measurement system is constructed by locating the light box, an aperture, a polarizing plate, a sample, another polarizing plate and a luminance meter in this order. Then, the sample is provided between the two polarizing plates in the crossed Nicols configuration. After rotating the sample so as to minimize the transmitted light, the front luminance is measured with the luminance meter. According to this method, namely, the easiness in lessening polarization caused by the aggregation of the liquid crystalline compound and orientation disorders thereof can be measured on the bases of an increase in the front luminance in the case where the scattering light enters into the sample via the polarizing plate as in a liquid crystal display device in practice. In the invention, the light leakage, which is measured by a convenient method as described above, can correspond to the front contrast of the liquid crystal display device having a polymer film bonded thereto. Namely, an increase in the light leakage indicates a lowering in the front contrast. The aperture is 3 cm×3 cm in size, the distance between the sample and the polarizing plate in the luminance measurement side is 15 cm, the distance between the polarizing plate and the luminance meter is 55 cm. As the light source, FUJI LIGHT BOX 5000 INVERTER (manufactured by Fuji Photo Film Co., Ltd.) is used. As the luminance meter, SR-3 (manufactured by TOPCON) is used and the measurement is conducted at 1° viewing angle.

(Polymer Film)

As the polymer material usable in the polymer film of the invention, there can be enumerated various transparent polymer resins without specific restriction. Namely, use may be made of polycarbonate, polyester, polyvinyl chloride, cellulose acylate, cycloolefin-based polymers and so on. Among all, it is preferred to use a polymer material which has a substantially flat wave length dispersion characteristics or reverse wavelength dispersion characteristics of the retardation in the visible light range. As an optical resin having such characteristics, it is still preferable to employ cellulose acylate. As the cellulose triacetate, it is particularly preferable to employ cellulose triacetate.

(Retardation)

In the present specification, Re(590) and Rth(590) represent an in-plane retardation and a retardation in the thickness direction at a wavelength of 590 nm, respectively. The Re(590) is measured by making light having a wavelength of 590 nm incident into the normal line direction in KOBRA 21ADH (manufactured by Oji Science Instruments). The Rth(590) is computed by KOBRA 21 ADH on the basis of retardation values, as measured in three directions in total, of the foregoing Re(590), a retardation value as measured by making light having a wavelength of 590 nm incident from a direction inclined by +40° against the normal line direction of the film while making the in-plane slow axis (judged by KOBRA 21ADH) serve as a tilt axis (rotational axis), and a retardation value as measured by making light having a wavelength of 590 nm incident from a direction inclined by −40° against the normal line direction of the film while making the in-plane slow axis serve as a tilt axis (rotational axis). Here, as hypothetical values of average refractive index, values described in Polymer Handbook (John Wiley & Sons, Inc.) and various catalogues of optical films can be employed. When an average refractive index value is not known, it can be measured by an Abbe's refractometer. Average refractive index values of major optical films are exemplified below: cellulose acylate (1.48), cycloolefin polymer (1.52), polycarbonate (1.59), polymethyl methacrylate (1.49), polystyrene (1.59). By inputting a hypothetical value of the average refractive index and a film thickness, KOBRA 21ADH computes nx, ny and nz.

From the viewpoint of the optical compensation in a VA mode liquid crystal cell, it is preferred that the polymer film of the invention has an in-plane retardation and a retardation in a thickness-direction which are satisfied with the ranges of the following expressions (A) and (B):
30 nm<|Re(590)|<300 nm (A)
30 nm<Rth(590)<400 nm (B)
wherein Re(590) indicates an in-plane retardation (expressed in nm) of the film at a wavelength of 590 nm; and Rth(590) indicates a retardation in a thickness-direction (expressed in nm) of the film at a wavelength of 590 nm.

The in-plane retardation Re and retardation Rth in a thickness-direction of the polymer film of the invention are preferably satisfied with the ranges of the following expressions (A) and (B):
30 nm<|Re(590)|<300 nm (A)
30 nm<Rth(590)<400 nm (B),
more preferably
50 nm<|Re(590)|<250 nm (A)
100 nm<Rth(590)<300 nm (B),
and particularly preferably
100 nm<|Re(590)|<200 nm (A)
150 nm<Rth(590)<250 nm (B).

The Re(590) and Rth(590) as described above can be controlled by altering the addition level of a retardation controlling agent, the degree of acetylation of cellulose acylate, film stretching conditions, film drying conditions, etc. though the invention is not restricted to these procedures.

(Compound Having Dielectric Constant ε of 4.0 or More)

Next the compound having a dielectric constant ε of 4.0 or more to be used in the invention will be illustrated.

As the compound having a dielectric constant ε of 4.0 or more to be used in the invention, use can be made of, for example, a compound which has been employed as a plasticizer. A plasticizer is added to develop a so-called plasticizing effect, e.g., imparting flexibility to a cellulose acylate film. When the liquid crystalline compound is hardly soluble in cellulose acylate, a plasticizer is sometimes added so that it serves as a good solvent to thereby provide an optically transparent film.

It is undesirable that the compound having a dielectric constant ε of 4.0 or more to be used in the invention has an excessively low dielectric constant, since the liquid crystalline compound easily crystallizes or aggregates in the film to cause troubles in planar properties, etc. When the dielectric constant thereof is excessively high, on the other hand, a retardation controller would be hardly oriented and little retardation can be developed.

It is preferable to add the compound having a dielectric constant ε of 4.0 or more to be used in the invention in an amount of from 5 to 50% by mass, more preferably from 7 to 30% by mass and particularly preferably from 10 to 20% by mass based on the polymer employed as the film material.

Preferable examples of the plasticizer having a dielectric constant ε of 4.0 or more to be used in the invention include those represented by the following formulae (S-1) to (S-7), though the invention is not restricted thereto so long as the dielectric constant falls within the desired range as specified above.

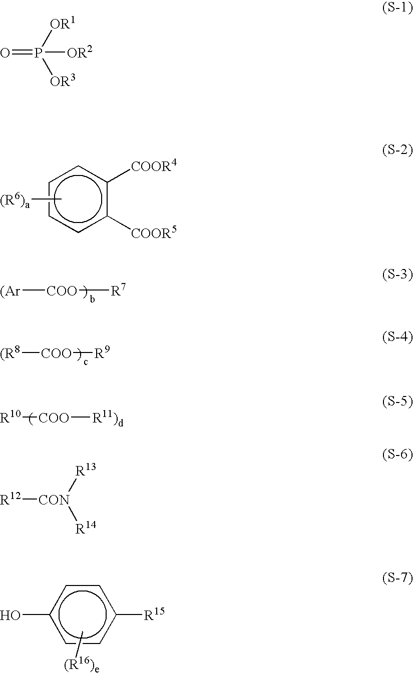

In the above formula (S-1), R¹, R² and R³ independently represent each an alkyl group, a cycloalkyl group or an aryl group.

In the above formula (S-2), R⁴ and R⁵ independently represent each an alkyl group, a cycloalkyl group or an aryl group; R⁶ represents a halogen atom (F, Cl, Br or I; the same will apply hereinafter), an alkyl group, an alkoxy group, an aryloxy group or an alkoxycarbonyl group; and a is an integer of from 0 to 3. In the case where a is 2 or more, the plural number of R⁶s may be either the same or different.

In the above formula (S-3), Ar represents an aryl group; b is an integer of from 1 to 6; and R⁷ represents a hydrocarbon group having a valency of b or hydrocarbon groups bonded together via an ether bond.

In the above formula (S-4), R⁸ represents an alkyl group or a cycloalkyl group; c is an integer of from 1 to 6; and R⁹ represents a hydrocarbon group having a valency of c or hydrocarbon groups bonded together via an ether bond.

In the above formula (S-5), d is an integer of from 2 to 6; R¹⁰ represents a hydrocarbon group (excluding an aromatic group) having a valency of d; and R¹¹ represents an alkyl group, a cycloalkyl group or an aryl group.

In the above formula (S-6), R¹², R¹³ and R¹⁴ independently represent each an alkyl group, a cycloalkyl group or an aryl group. Alternatively, R¹² and R¹³, or R¹³ and R¹⁴ may be bonded together to form a ring.

In the above formula (S-7), R¹⁵ represents an alkyl group, a cycloalkyl group, an alkoxycarbonyl group, an alkylsulfonyl group, an arylsulfonyl group, an aryl group or a cyano group; R¹⁶ represents a halogen atom, an alkyl group, a cycloalkyl group, an aryl group, an alkoxy group or an aryloxy group; and e is an integer of 0 to 3. In the case where e is 2 or more, the plural number of R¹⁶s may be either the same or different.

Next, specific examples of the compound having a dielectric constant ε of 4.0 or more to be used in the invention will be presented, though the invention is not restricted thereto.

| | | *1 |
|---|---|---|
| | | 25° C. 10 KHz |
| P-1 | 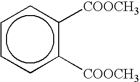 | 8.52 |
| 2 | 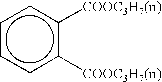 | 6.42 |
| 3 | 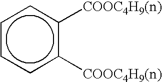 | 6.45 |
| 4 | 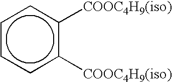 | 6.52 |
| 5 | 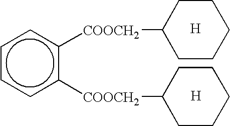 | 6.44 |
| 6 | 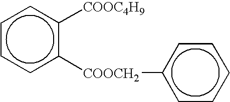 | 6.56 |
| 7 | 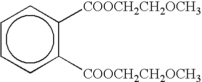 | 8.72 |
| 8 | 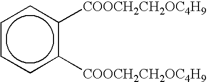 | 6.78 |
| 9 | 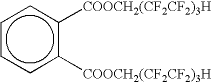 | 8.87 |
| 10 | 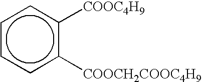 | 6.96 |
| 11 | 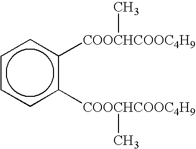 | 6.99 |
| 12 | 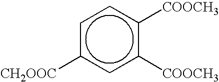 | 9.09 |
| 13 | 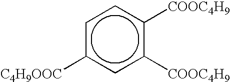 | 6.07 |
| 14 | 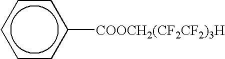 | 6.46 |
| 15 | 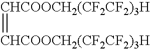 | 7.67 |
| 16 | 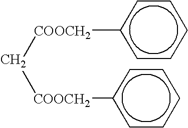 | 6.12 |
| 17 | 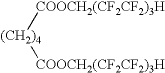 | 7.24 |
| 19 | 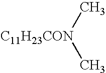 | 13.18 |
| 20 | 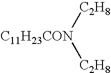 | 13.45 |
| 21 | 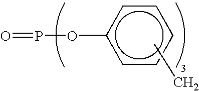 | 7.33 |
| 22 | 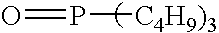 | 8.30 |
| 23 | 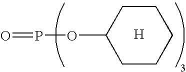 | 7.34 |
| 24 | 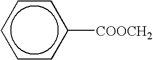 | 6.43 |
| 25 | 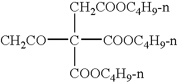 | 6.02 |
| *1: Dielectric constant | | |

The numerical values given in the right column in the above table indicates the dielectric constants (25° C., 10 kHz) of the individual compounds. Examples of compounds usable in the invention other than those cited above and/or methods of synthesizing the same are described in, for example, U.S. Pat. No. 2,322,027, U.S. Pat. No. 2,533,514, U.S. Pat. No. 2,772,163, U.S. Pat. No. 2,835,579, U.S. Pat. No. 3,676,137, U.S. Pat. No. 3,912,515, U.S. Pat. No. 3,936,303, U.S. Pat. No. 4,080,209, U.S. Pat. No. 4,127,413, U.S. Pat. No. 4,193,802, U.S. Pat. No. 4,239,851, U.S. Pat. No. 4,278,757, U.S. Pat. No. 4,363,873, U.S. Pat. No. 4,483,918, U.S. Pat. No. 4,745,049, EP 276,319A, JP-A-48-47335, JP-A-51-149028, JP-A-61-84641, JP-A-62-118345, JP-62-247364, JP-A-63-167357, JP-A-64-68745 and JP-A-01-101543.

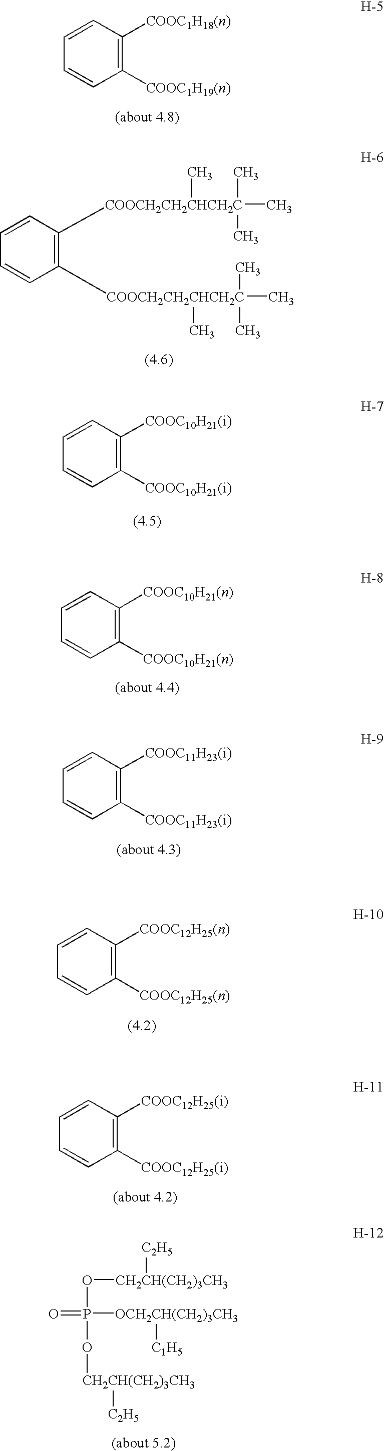

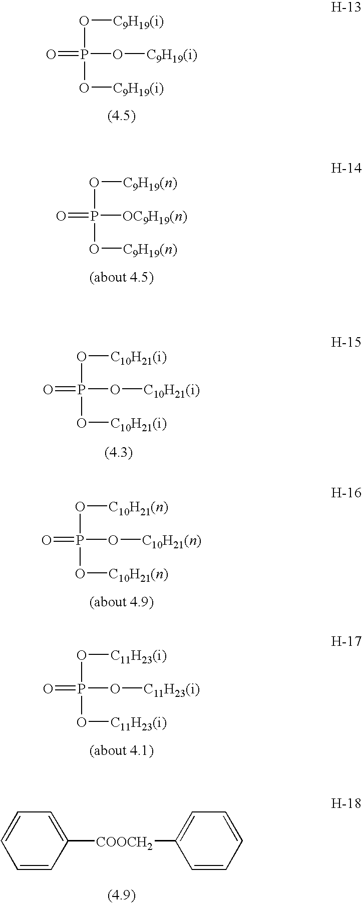

The numerical values given in parentheses indicate the dielectric constants (25° C., 10 kHz) of the individual compounds.

It is preferable that the polymer film of the invention is a film produced by using cellulose acylate as the polymer material (hereinafter referred to as a cellulose acylate film). Next, the cellulose acylate film preferably usable in the invention will be described in greater detail.

[Starting Cotton Material for Synthesizing Cellulose Acylate]

Examples of the starting cellulose to be used for synthesizing the cellulose acylate in the invention include cotton linter and wood pulp (hardwood pulp and softwood pulp). Use can be made of cellulose acylate obtained from any cellulose material and a mixture is also usable in some cases. These starting cotton materials are described in detail in, for example, Purasuchikku Zairyo Koza (17), Senisokei Jushi (Marusawa and Uda, The Nikkan Kogyo Shinbun, Ltd. 1970) and Japan Institute of Invention and Innovation Journal of Technical Disclosure No. 2001-1745, p. 7 to 8, though the material of the cellulose acylate film of the invention is not particularly restricted thereto.

[Degree of Substitution in Cellulose Acylate]

Now, the cellulose acylate which is produced starting with the cellulose material as described above will be illustrated. In the cellulose acylate in the invention, hydroxyl groups in cellulose have been acylated. As the substituents, use may be made of acetyl groups having from 2 to 22 carbon atoms. In the cellulose acylate to be used in the invention, the degree of substitution of hydroxyl groups in the cellulose is not particularly restricted. The substitution degree can be determined by measuring the degree of binding of acetic acid and/or fatty acids having from 3 to 22 carbon atoms substituting hydroxyl groups in cellulose and calculating. The measurement can be carried out in accordance with ASTM D-817-91.

As discussed above, it is preferable that the degree of substitution of hydroxyl groups in the cellulose acylate of the invention is not particularly restricted. The degree of acylation of hydroxyl groups in the cellulose preferably ranges from 2.50 to 3.00, more preferably from 2.75 to 3.00 and more preferably from 2.85 to 3.00.

Among the acetic acid or fatty acids having from 3 to 22 carbon atoms substituting hydroxyl groups in cellulose, the acyl group having from 2 to 22 carbon atoms may be an aliphatic group or an allyl group without restriction. Either a single group or a mixture of two or more groups may be used. Use may be made of, for example, alkylcarbonyl esters, alkenylcarbonyl esters, aromatic carbonyl esters and aromatic alkylcarbonyl esters of cellulose each optionally having additional substituents. Preferable examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl groups. Among them, acetyl, propionyl, butanoyl, dodecanoyl, octadecanoyl, t-butanoyl, oleoyl. benzoyl, naphthylcarbonyl and cinnamoyl groups are preferable, and acetyl, propionyl and butanoyl groups are more preferable.

As the results of intensive studies by the inventor, it is found out that, in the case where the acyl substituents substituting hydroxyl groups in the cellulose substantially comprise at least two groups selected from among acetyl, propionyl and butanoyl groups, the optical anisotropy of the cellulose acylate film can be lowered in the case the total degree of substitution thereof ranging from 2.50 to 3.00. Namely, the degree of acylation more preferably ranges from 2.60 to 3.00 and still preferably from 2.65 to 3.00.

[Degree of Polymerization of Cellulose Acylate]

The degree of polymerization (expressed in viscosity-average degree of polymerization) of the cellulose acylate to be used in the invention ranges preferably from 180 to 700. In cellulose acetate, the degree of polymerization preferably ranges from 180 to 550, more preferably from 180 to 400 and particularly preferably from 180 to 350. In the case where the degree of polymerization is too high, a dope solution of the cellulose acylate has a high viscosity and, in its turn, a film can be hardly formed by casting. At an excessively low degree of polymerization, on the other hand, the obtained film has only a low strength. An average degree of polymerization can be measured by the limiting viscosity method (Kazuo Uda & Hideo Saito, SEN-I GAKKAISHI, Vol. 18, No. 1, p. 105-120, 1962). This method is reported in greater detail in JP-A-9-95538.

The molecular weight distribution of the cellulose acylate preferably used in the invention is evaluated by gel permeation chromatography. A smaller polydispersity index Mw/Mn (Mw: mass-average molecular weight, Mn: number-average molecular weight) and a narrower molecular weight distribution are preferred. More specifically speaking, Mw/Mn preferably ranges from 1.0 to 3.0, more preferably form 1.0 to 2.0 and most desirably from 1.0 to 1.6.

When low-molecular weight components are removed, the average molecular weight (degree of polymerization) is elevated but the viscosity becomes lower than common cellulose acylates, thereby becoming useful. Cellulose acylate containing less low-molecular weight components can be obtained by removing the low-molecular weight components from cellulose acylate synthesized by a conventional method. The low-molecular weight components can be removed by washing cellulose acylate with an appropriate organic solvent. In the case of producing cellulose acylate containing less low-molecular weight components, it is preferable to control the amount of the sulfuric acid catalyst in the acetylation to 0.5 to 25 parts by mass per 100 parts by mass of cellulose. By controlling the amount of the sulfuric acid catalyst within the range as described above, it is possible to synthesize cellulose acylate favorable from the viewpoint of molecular weight distribution (i.e., having a uniform of molecular weight distribution). In using the production of cellulose acylate according to the invention, the water content ratio is preferably 2% by mass or less, more preferably 1% by mass or less and particularly preferably 0.7% by mass or less. In general, cellulose acylate contains water and it is known that the water content ratio thereof ranges from 2.5 to 5% by mass. To regulate to this water content ratio of cellulose acylate in the invention, it is required to dry the cellulose acylate. The drying method is not particularly restricted, so long as the desired water content ratio can be established thereby. As the starting cotton material and the synthesis method to be used for obtaining the cellulose acylate, use can be made of the starting cotton material and the synthesis method described in detail in Japan Institute of Invention and Innovation Journal of Technical Disclosure No.2001-1745 (2001.03.15, Japan Institute of Invention and Innovation), p. 7 to 12.

As the cellulose acylate according to the invention, use can be made of either a single cellulose acylate or a mixture of two or more cellulose acylates so long as these cellulose acylates fulfill the requirements in substituent, degree of substitution, degree of polymerization, molecular weight distribution and so on as described above.

[Organic Solvent of Cellulose Acylate Solution]

In the invention, it is preferred to produce the cellulose acylate film by the solvent casting method. In this method, a film is produced by using a cellulose acylate solution dissolved in an organic solvent (a dope). As preferable examples of the organic solvent to be used as the main solvent in the invention, use may be preferably made of solvents selected from among esters, ketones, ethers having from 3 to 12 carbon atoms and halogenated hydrocarbons having from 1 to 7 carbon atoms. These esters, ketones and ethers may have cyclic structure. It is also possible to use, as the main solvent, compounds having two or more functional groups (i.e., —O—, —CO— and —COO—) of esters, ketones and ethers and these compounds may have another functional group such as alcoholic hydroxyl group at the same time. In the case of a main solvent having two or more types of functional groups, the carbon atom number falling within the range as specified above concerning a compound having one of the functional groups.

As described above, the cellulose acylate film according to the invention may comprise, as the main solvent, either a chlorine-based halogenated hydrocarbon or a nonchlorinated organic solvent as described in Japan Institute of Invention and Innovation Journal of Technical Disclosure No. 2001-1745 (p. 12 to 16). The cellulose acylate film of the invention is not restricted thereto.

Other solvents for the cellulose acylate solution and film according to the invention and dissolution methods therefore are disclosed in the following patents which are preferred embodiments: for example, JP-A-2000-95876, JP-A-12-95877, JP-A-10-324774, JP-A-08-152514, JP-A-10-330538, JP-A-09-95538, JP-A-09-95557, JP-A-10-235664, JP-A-12-63534, JP-A-11-21379, JP-A-10-182853, JP-A-10-278056. JP-A-10-279702, JP-A-10-323853, JP-A-10-237816, JP-A-11-60307, JP-A-11-152342, JP-A-11-292988, JP-A-11-60752 and so on. According to these patents, not only preferable solvents for the cellulose acylate of the invention but also solution properties thereof and substances to coexist are reported, thereby presenting preferred embodiments of the invention.

In addition to the liquid crystalline compound and the compound having a dielectric constant ε of 4.0 or more as described above, the cellulose acylate film according to the invention may contain various additives (for example, a plasticizer, an ultraviolet blocking agent, an antidegradant, a peeling accelerator, an infrared absorbing agent and a retardation controlling agent). These additives may be either solid substances or oily substances. Namely, they are not particularly restricted in melting point or boiling point. For example, it is possible to use a mixture of an ultraviolet absorbing agent having a melting point of 20° C. or lower with another ultraviolet absorbing agent having a melting point of 20° C. or higher. Similarly, use can be made of a mixture of plasticizers as reported by, for example, JP-A-2001-151901. Examples of the infrared absorbing dye are given in, for example, JP-A-2001-194522. Although these additives may be added at any stage during the dope preparation, a preparation step of adding the additives may be further employed as the final step of the dope preparation process. The addition level of each material is not particularly restricted, so long as the desired effect thereof can be achieved. In the case of a multilayered cellulose acylate film, moreover, individual layers may contain different types of additives in various amounts. These techniques have been conventionally known, as reported by, for example, JP-A-2001-151902. Concerning additives, moreover, use can be optionally made of the substances described in detail in Japan Institute of Invention and Innovation Journal of Technical Disclosure No. 2001-1745 (2001.03.15, Japan Institute of Invention and Innovation), from p. 16 to p. 22.

[Process for Producing Cellulose Acylate Film]

[Dissolution Step]

In preparing a cellulose acylate solution (dope) of the invention, the cellulose acylate is dissolved by an arbitrary method without restriction, i.e., by room-temperature dissolution, cold dissolution, hot dissolution or a combination thereof. Concerning the preparation of the cellulose acylate solution according to the invention, concentration of the solution in association with the dissolution and filtration, it is preferable to employ the process described in, for example, Japan Institute of Invention and Innovation Journal of Technical Disclosure No. 2001-1745 (2001.03.15, Japan Institute of Invention and Innovation), p. 22 to 25.

(Transparency of Dope Solution)

It is preferable that the transparency of the dope of the cellulose acylate solution according to the invention is 85% or higher, more preferably 88% or higher and more preferably 90% or higher. In the invention, it is confirmed that various additives have been sufficiently dissolved in the cellulose acylate dope solution. The dope transparency in practice is determined by pouring the dope solution into a glass cell (1 cm×1 cm), measuring the absorbance at 550 nm with a spectrophotometer (UV-3150, manufactured by Shimadzu), separately measuring the solvent alone as a blank, and then calculating the transparency of the cellulose acylate solution based on the ratio to the absorbance of the blank having been measured by using the solvent alone.

[Casting, Drying and Winding Steps]

Next, a method of producing a film by using the cellulose acylate solution of the invention will be illustrated. Concerning a film-forming method and an apparatus for producing the cellulose acylate film of the invention, use can be made of the solvent cast film-forming method and a solvent cast film-forming apparatus conventionally employed in forming cellulose triacetate films. A dope (a cellulose acylate solution) prepared in a dissolution machine (a pot) is once stored in a storage pot and, after defoaming, the dope is subjected to the final preparation. Then the dope is discharged from a dope exhaust and fed into a pressure die via, for example, a pressure constant-rate pump whereby the dope can be fed at a constant rate at a high accuracy depending on the rotational speed. From the pipe sleeve (slit) of the pressure die, the dope is uniformly cast onto a metallic support continuously running in the casting section. At the peeling point where the metallic support has almost rounded, the half-dried dope film (also called a web) is stripped off from the metallic support. The obtained web is clipped at both ends and dried by carrying with a tenter while maintaining the width at a constant level. Subsequently, it is mechanically carried with rolls in a dryer to terminate the drying and then wound with a winder in a definite length. Combination of the tenter and the rolls in the dryer may vary depending on the purpose. In the solvent cast film-forming method to produce functional protective films for electronic displays or silver halide photosensitive materials (i.e., the main uses of the cellulose acylate film of the invention), a coater is frequently employed, in addition to the solvent cast film-forming apparatus, so as to process the film surface by providing, for example, an undercoating layer, an antistatic layer, an anti-halation layer or a protective layer. These layers are described in detail in Japan Institute of Invention and Innovation Journal of Technical Disclosure No. 2001-1745 (2001.03.15, Japan Institute of Invention and Innovation), p. 25 to 30. The techniques given in this document, which are itemized as casting (including co-casting), metallic supports, drying, peeling and so on, are preferably usable in the invention.

The thickness of the cellulose acylate film is preferably from 10 to 120 μm, more preferably from 20 to 100 μm and more preferably from 30 to 90 μm.

[Stretching Step]

It is preferable that the cellulose acylate film of the invention is subjected to a stretching treatment. By performing the stretching treatment, it is possible to impart desired retardation to the cellulose acylate film by orienting cellulose acylate and the liquid crystalline compound.

As a stretching method, there can be enumerated the free uniaxial stretching method in the longitudinal direction with the use of a difference in circumeferential speed between two or more rolls, the fixed uniaxial tenter stretching method in the width direction while clipping the polymer film at both sides with holders such as tenter clips, and so on, though the invention is not restricted thereto. In the invention, the stretching magnification is preferably from 1.05- to 2.00-fold, more preferably from 1.10- to 1.5-fold and particularly preferably from 1.15- to 1.3-fold.

The amount of the solvent remaining in the stretched polymer film is not particularly restricted. That is to say, the film containing a large amount of high-volatile components immediately after stripped off from the band may be stretched. Alternatively, the film may be once dried and then stretched. In the invention, the amount of the residual solvent is preferably from 5 to 50% by mass, more preferably from 10 to 40% by mass and particularly preferably from 15 to 30% by mass.

[Functional Layer]

The polymer film of the invention is usable for optical purposes and photographic sensitive materials. It is particularly preferable to use the polymer film of the invention in a liquid crystal display device as an optical purpose. In a still preferable case, the liquid crystal display device has a constitution comprising a liquid crystal cell, which holds liquid crystals between two electrode substrates, two polarizing plates provided in both sides of the liquid crystal cell, and at least one optically compensatory film provided between the liquid crystal cell and the polarizing plate. Preferable examples of such liquid crystal display devices include those in the TN, IPS, FLC, AFLC, OCB, STN, ECB and HAN modes.

In using the polymer film of the invention for the optical purposes as described above, it is a practice to form various functional layers, for example, an antistatic layer, a hardened resin layer (various hard coat layers, an antireflective layer, an adhesion-facilitating layer, an antiglare layer, an optically compensatory layer, an orientation layer, a liquid crystal layer and so on. As these functional layers usable in the polymer film of the invention and materials thereof, there can be enumerated a surfactant, a lubricant, a matting agent, an antistatic layer, a hard coat layer and so on which are described in detail in Japan Institute of Invention and Innovation Journal of Technical Disclosure No. 2001-1745 (2001.03.15, Japan Institute of Invention and Innovation), p. 32 to 45. The materials given in this document are preferably usable in the present invention.

[Usage (Polarizing Plate)]

Next, the usage of the polymer film of the invention will be described.

The polymer film of the invention is particularly useful as a protective film for a polarizing plate. In the case of using the polymer film of the invention as a protective film for a polarizing plate, the polarizing plate may be constructed by a usually employed method without specific restriction. A common method comprises treating the obtained polymer film with an alkali and then laminating on both faces of a polarizer, which has been constructed by dipping a polyvinyl alcohol film in an iodine solution and stretching, by using a completely saponified aqueous polyvinyl alcohol solution. As an alternative for the alkali treatment, use may be made of a treatment for facilitating adhesion as reported in JP-A-6-94915 or JP-A-6-118232.

Examples of the adhesive to be used for laminating the treated face of the protective film on the polarizer include polyvinyl alcohol-based adhesives such as polyvinyl alcohol and polyvinyl butyral, vinyl-based latexes such as butyl acrylate and so on.

The polarizing plate is composed of the polarizer and the protective films protecting both faces thereof. It further has a protect film on one face of the polarizing plate and a separate film on the opposite face thereof. The protect film and the separate film are employed in order to protect the polarizing plate during shipment, product inspection and other steps. In this case, the protect film, which aims at protecting the surface of the polarizing plate, is laminated on the face opposite to the face to be laminated on a liquid crystal plate. On the other hand, the separate film, which aims at covering the adhesive layer to be boned to the liquid crystal plate, is laminated on the face of the polarizing plate to be laminated on the liquid crystal face.

In a liquid crystal display device, a substrate containing liquid crystals is usually provided between two polarizing plates. The protective film for polarizing plate comprising the polymer film of the invention enables the achievement of excellent display characteristics at any site. It is particularly preferable to use the protective film for polarizing plate as a protective film for polarizing plate as the outmost layer in the display side of a liquid crystal display device, since a transparent hard coat layer, an antiglare layer, an antireflective layer, etc. are formed therein.

(Constitution of Commonly Used Liquid Crystal Display Device)

In the case of using the polymer film as the optically compensatory sheet (film), the transmission axis of the polarizing plate and the slow axis of the optically compensatory film may be located at an arbitrary angle. A liquid crystal display device comprises a liquid crystal cell having liquid crystals between a pair of electrode substrates, two polarizing plates provided in both sides of the cell, and at least one optically compensatory film provided between the liquid crystal cell and the polarizing plate.

The liquid crystal layer of the liquid crystal cell is usually constructed by enclosing liquid crystals into a space formed by inserting a spacer between two substrates. A transparent electrode layer is formed as a transparent membrane containing an electrically conductive substance. The liquid crystal cell may further have a gas barrier layer, a hard coat layer or an under coat layer (employed for laminating the transparent electrode layer). These layers are usually formed on the substrate. The thickness of the liquid crystal cell substrate is generally from 50 μm to 2 mm.

[Liquid Crystal Display Device Modes]

The polymer film of the invention is usable in liquid crystal display devices in various display modes. There have been proposed various display modes, for example, TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), ECB (electrically controlled birefringence) and HAN (hybrid aligned nematic) modes. There have been further proposed display modes obtained by split orientation of the above display modes. The polymer film of the invention is effective in liquid crystal display devices in any of these display modes. It is also effective in liquid crystal display devices of transmission, reflection and semi-transmission modes.

(Liquid Crystal Display Device of TN Mode)

The polymer film of the invention may be used as the support of an optically compensatory sheet in a TN mode liquid crystal display device having a liquid crystal cell in the TN mode. Liquid crystal cells in the TN mode and liquid crystal display devices of the TN mode have been well known for a long time. Optically compensatory sheets to be used in TN mode liquid crystal display devices are described in JP-A-3-9325, JP-A-6-148429, JP-A-8-50206 and JP-A-9-26572 and also reported by Mori, et al., Jpn. J. Appl. Phys., vol. 36 (1997), p. 143 and Jpn. J. Appl. Phys., vol. 36 (1997), p. 1068

(Liquid Crystal Display Device of STN Mode)

The polymer film of the invention may be used as the support of an optically compensatory sheet in an STN mode liquid crystal display device having a liquid crystal cell in the STN mode. In general, rod-shaped liquid crystal molecules in the liquid crystal cell of an STN mode liquid crystal display device are twisted by 90 to 360° and the product (Δnd) of the refractive anisotropy (Δn) of the rod-shaped liquid crystal molecule and the cell gap (d) ranges from 300 to 1500 nm. Optically compensatory sheets usable in the STN mode liquid crystal display devices are described in JP-A-2000-105316.

(Liquid Crystal Display Device of VA Mode)

The polymer film of the invention may be particularly advantageously used as the support of an optically compensatory sheet in a VA mode liquid crystal display device having a liquid crystal cell in the VA mode. It is preferable to control the Re retardation and the Rth retardation of the optically compensatory sheet to be used in a VA mode liquid crystal display unit respectively to 0 to 150 nm and 70 to 400 nm. It is still preferable to control the Re retardation to 20 to 70 nm. In the case of using two optically anisotropic polymer films in a liquid crystal display unit of the VA mode, the Rth retardations of the films preferably range from 70 to 250 nm. In the case of using a single optically anisotropic polymer film in a liquid crystal display unit of the VA mode, the Rth retardation of the film preferably ranges from 150 to 400 nm. Use may be also made of a liquid crystal display unit of the VA mode in the split orientation system as described in, for example, JP-A-J10-123576.

(Liquid Crystal Display Device of IPS Mode and Liquid Crystal Display Device of ECB Mode)

The polymer film of the invention may be particularly advantageously used as the support of an optically compensatory sheet or a protective film for a polarizing plate in an IPS mode liquid crystal display device having a liquid crystal cell in the IPS mode or an ECB mode liquid crystal display device having a liquid crystal cell of the ECB mode, or a protective film of a polarizing plate therein. In these modes, a liquid crystal material is oriented almost in parallel in black display. Namely, liquid crystal molecules are oriented in parallel with the substrate plane under loading no voltage, thereby giving black display. A polarizing plate having the polymer film of the invention contributes to the enlargement in viewing angle and the improvement in contrast in these modes. In this embodiment, it is favorable to employ a polarizing plate with the use of a polymer film of the invention as the protective film located between the liquid crystal cell and the polarizing plate (i.e., the protective film in the cell side) of the polarizing plate-protective films provided above and below the liquid crystal cell, at least in one side of the liquid crystal cell. It is still favorable in these modes to control the retardation of the optically anisotropic layer provided between the protective films of the polarizing plate and the liquid crystal cell to not more than twice of Δnd.

(Liquid Crystal Display Device of OCB Mode and Liquid crystal Display device of HAN Mode)

The polymer film of the invention may be also advantageously used as the support of an optically compensatory sheet in an OCB mode liquid crystal display device having a liquid crystal cell in the OBC mode or a HAN mode liquid crystal display device having a liquid crystal cell in the HAN mode. It is preferable that an optically compensatory sheet to be used in an OCB mode liquid crystal display device or a HAN mode liquid crystal display device has a direction giving the minimum absolute retardation value neither in the optically compensatory sheet plane nor in the normal line direction. The optical properties of an optically compensatory sheet to be used in an OCB mode liquid crystal display device or a HAN mode liquid crystal display device are determined depending on the optical properties of the optically anisotropic layer, the optical properties of the support and the configuration of the optically anisotropic layer and the support. Optically compensatory sheets to be used in an OCB mode liquid crystal display device or a HAN mode liquid crystal display device are described in JP-A-9-197397 and also reported by Mori, et al., Jpn. J. Appl. Phys., Vol. 38 (1999), p. 2837.

(Liquid Crystal Display Device of Reflection Mode)

The polymer film of the invention may be also advantageously used as the support of an optically compensatory sheet in reflection mode liquid crystal display devices such as TN mode, STN mode, HAN mode and GH (guest-host) mode. These display modes have been well known for a long time. Liquid crystal display devices of the TN reflection mode are described in JP-A-10-123478, WO 9848320 and Japanese Patent No. 3022477, while an optically compensatory sheet to be used in a reflection mode liquid crystal display device is described in WO 00-65384.

(Other Liquid Crystal display Devices)

The polymer film of the invention may be also advantageously used as the support of an optically compensatory sheet in an ASM (axially symmetric aligned microcell) mode liquid crystal display device having a liquid crystal cell in the ASM mode. A liquid crystal cell of the ASM mode is characterized by being held by a resin spacer allowing to control the cell thickness from site to site. Other properties thereof are the same as liquid crystal cells in the TN mode. A liquid crystal cell in the ASM mode and an ASM mode liquid crystal display device are reported by Kume et al., SID 98 Digest 1089 (1998).

In the invention, a liquid crystal cell in the VA mode is particularly preferred.

### EXAMPLES

Next, examples of the invention will be provided, though the invention is not construed as being restricted thereto.

### Example 1

(Production of Cellulose Acetate Films 001 to 036)

The composition as will be shown below was fed into a mixing tank and stirred under heating to thereby dissolving individual components, thus giving a cellulose acetate solution A.

<Composition of Cellulose Acetate Solution A>

| | | |
|---|---|---|
| cellulose acetate (acylation ratio: 2.86) | 100 | parts by mass |
| compound represented by Cpd. A-1 (plasticizer) | 11.7 | parts by mass |
| methylene chloride (first solvent) | 402.0 | parts by mass |
| methanol (second solvent) | 60.0 | parts by mass |

The composition as will be shown below was fed into another mixing tank and stirred under heating to thereby dissolving individual components, thus giving a cellulose acetate solution B.

<Composition of Additive Solution B>

| | |
|---|---|
| methylene chloride (first solvent) | 80 parts by mass |
| methanol (second solvent) | 20 parts by mass |
| liquid crystalline compound (Cpd. 1-1) | 30 parts by mass |
| (Preparation of fine microparticle dispersion C) | |

The composition as will be shown below was fed into another mixing tank and stirred under the following dispersion conditions, thus giving a microparticle dispersion C.

20 parts by mass of silica particles having a mean particle size of 16 nm (AEROSIL R972 by Nippon Aerosil) and 80 parts by mass of methanol were well stirred and mixed for 30 minutes to prepare a dispersion of silica particles. The dispersion was put into a disperser together with the following composition thereinto, and further stirred therein for at least 30 minutes to dissolve the components, thereby preparing a microparticle dispersion C.

(Microparticle Dispersion C)

| | |
|---|---|
| dispersion of silica particles | 10.0 parts by mass |
| methylene chloride (first solvent) | 76.3 parts by mass |
| methanol (second solvent) | 3.4 parts by mass |
| cellulose acylate solution (CAL-1) | 10.3 parts by mass |

<Production of Cellulose Acetate Film 001>

10 parts by mass of the microparticle dispersion C was added to 20 parts by mass of the additive solution B. After stirring, the mixture was added to 477 parts by mass of the cellulose acylate solution A and thoroughly stirred to give a dope. The dope was cast from a casting port on a band having been cooled to 10° C. The dope was stripped off at a solvent content of 50% by mass. In the state at a solvent content of 5% to 40% by mass, it was tenter-stretched at a stretching magnification of 1.08 in the widthwise direction (the direction perpendicular to the mechanical direction). Next, it was further dried by transporting between heater rolls to give a cellulose acylate film 001 of 80 μm in thickness.

(Measurement of Light Leakage)

In accordance with the method as described above, light leakage of the cellulose acylate film 001 thus obtained was measured. The front luminance measured with the use of a single polarizing plate was 920 cd/m² and the front luminance measured with the use of two polarizing plates in the crossed Nicols configuration was 0.13 cd/m².

Cellulose acylate films 002 to 036 were produced in the same manner but using the liquid crystalline compounds and plasticizers (each in the same amount) as listed in Table 1.

Table 1 shows the results of the measurement of hazes, retardations and light leakages of the cellulose acylate samples 001 to 036 thus obtained.

Tables 2 to 5 show the structures of the liquid crystalline compounds and the plasticizers employed.

TABLE 1

| | Liquid | | | | | | | | | | |
|---|---|---|---|---|---|---|---|---|---|---|---|
| | crystalline compound | | Plasticizer | | | | | | Light | | |
| | | Liquid | | Dielectric | | | Retardation | | leakage | | |
| Film No. | Type | crystallinity | Type | constant | Indication*1 | Haze | Re | Rth | Measured | Ratio*2 | Category |
| 001 | Cpd.1-1 | Yes | Cpd.A-1 | 3.26 | A | 2.0 | 129 | 221 | 0.32 | 2.5 | Comparison |
| 002 | | | Cpd.A-2 | 4.31 | A | 1.3 | 130 | 220 | 0.24 | 1.8 | Invention |
| 003 | | | Cpd.B-1 | 4.85 | B | 1.3 | 129 | 218 | 0.22 | 1.7 | |
| 004 | | | Cpd.B-2 | 5.37 | B | 1.2 | 130 | 221 | 0.20 | 1.5 | |
| 005 | | | Cpd.B-3 | 5.65 | B | 1.3 | 128 | 214 | 0.15 | 1.2 | |
| 006 | | | Cpd.B-4 | 6.07 | B | 1.1 | 124 | 203 | 0.16 | 1.2 | |
| 007 | | | Cpd.C-1 | 6.90 | C | 1.1 | 96 | 162 | 0.14 | 1.1 | |
| 008 | | | Cpd.C-2 | 7.68 | C | 1.2 | 90 | 158 | 0.16 | 1.2 | |
| 009 | | | Cpd.C-3 | 21.00 | C | 0.8 | 83 | 153 | 0.15 | 1.2 | |
| 010 | Cpd.1-2 | Yes | Cpd.A-3 | 3.97 | A | 1.8 | 93 | 209 | 0.35 | 2.7 | Comparison |
| 011 | | | Cpd.A-4 | 4.38 | A | 1.3 | 88 | 203 | 0.25 | 1.9 | Invention |
| 012 | | | Cpd.B-5 | 5.17 | B | 1.2 | 92 | 208 | 0.15 | 1.2 | |
| 013 | | | Cpd.B-2 | 5.37 | B | 1.3 | 87 | 207 | 0.16 | 1.2 | |
| 014 | | | Cpd.B-6 | 5.72 | B | 0.9 | 88 | 204 | 0.15 | 1.2 | |
| 015 | | | Cpd.B-7 | 6.12 | B | 0.8 | 84 | 187 | 0.14 | 1.1 | |
| 016 | | | Cpd.C-1 | 6.90 | C | 0.4 | 65 | 132 | 0.14 | 1.1 | |
| 017 | | | Cpd.C-2 | 7.68 | C | 0.5 | 59 | 128 | 0.15 | 1.2 | |
| 018 | | | Cpd.C-4 | 13.71 | C | 0.3 | 53 | 119 | 0.14 | 1.1 | |
| 019 | Cpd.2-1 | Yes | Cpd.A-5 | 4.00 | A | 1.1 | 65 | 178 | 0.39 | 3.0 | Invention |
| 020 | | | Cpd.A-6 | 4.16 | A | 0.9 | 64 | 179 | 0.23 | 1.8 | |
| 021 | | | Cpd.B-8 | 5.18 | B | 0.8 | 62 | 182 | 0.14 | 1.1 | |
| 022 | | | Cpd.B-9 | 5.50 | B | 0.6 | 65 | 173 | 0.15 | 1.2 | |
| 023 | Cpd.3-1 | Yes | Cpd.A-1 | 3.26 | A | 2.4 | 37 | 76 | 0.35 | 2.7 | Comparison |
| 024 | | | Cpd.A-3 | 3.97 | A | 2.2 | 38 | 81 | 0.30 | 2.3 | |
| 025 | | | Cpd.B-1 | 4.85 | B | 1.5 | 36 | 79 | 0.26 | 2.0 | Invention |
| 026 | | | Cpd.B-6 | 5.72 | B | 1.4 | 38 | 84 | 0.26 | 2.0 | |
| 027 | | | Cpd.C-2 | 7.68 | C | 1.3 | 36 | 67 | 0.23 | 1.8 | |
| 028 | | | Cpd.C-3 | 21.00 | C | 1.0 | 33 | 66 | 0.24 | 1.8 | |
| 029 | Cpd.4-1 | No | Cpd.A-7 | 3.23 | A | 1.6 | 28 | 56 | 0.18 | 1.4 | Comparison |
| 030 | | | Cpd.A-2 | 4.31 | A | 1.1 | 26 | 53 | 0.19 | 1.5 | |
| 031 | | | Cpd.B-2 | 5.37 | B | 0.8 | 25 | 55 | 0.20 | 1.5 | |
| 032 | | | Cpd.B-7 | 6.12 | B | 0.5 | 27 | 52 | 0.22 | 1.7 | |
| 033 | Cpd.24-1 | Yes | Cpd.A-1 | 3.26 | A | 2.5 | 25 | 141 | 0.42 | 3.2 | Comparison |
| 034 | | | Cpd.A-3 | 3.97 | A | 2.3 | 24 | 138 | 0.35 | 2.7 | |
| 035 | | | Cpd.C-2 | 7.68 | C | 1.0 | 18 | 125 | 0.18 | 1.4 | Invention |
| 036 | | | Cpd.C-3 | 21.00 | C | 0.7 | 15 | 120 | 0.16 | 1.2 | |
| Crossed | — | — | — | — | — | — | — | — | 0.13 | — | |
| Nicols | | | | | | | | | | | |

*1Solubility of plasticizer. A: Soluble at room temperature. B: Insoluble at room temperature but soluble under heating to 90° C. C: Insoluble even under heating to 90° C.
*2Ratio calculated as follows. Ratio = (measured light leakage in the presence of polymer film)/(measured light leakage in the crossed Nicols configuration).

TABLE 2

| Film No. | Type | Structural formula |
|---|---|---|
| 001 002 003 004 005 006 007 008 009 | Cpd.1-1 | 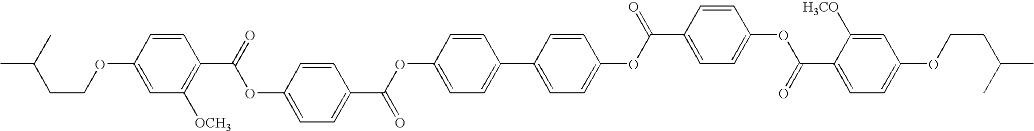 |
| 010 011 012 013 014 015 016 017 018 | Cpd.1-2 | 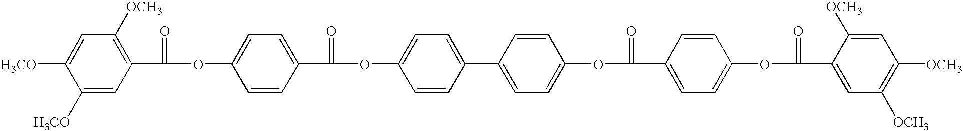 |
| 019 020 021 022 | Cpd.2-1 | 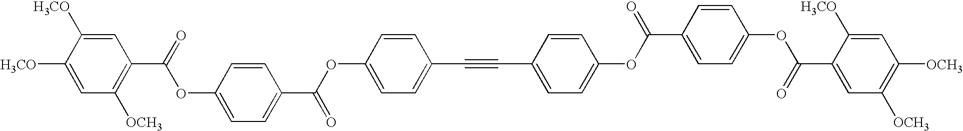 |
| 023 024 025 026 027 028 | Cpd.3-1 | 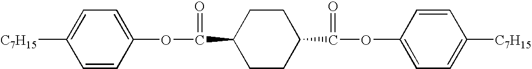 |
| 029 030 031 032 | Cpd.4-1 | 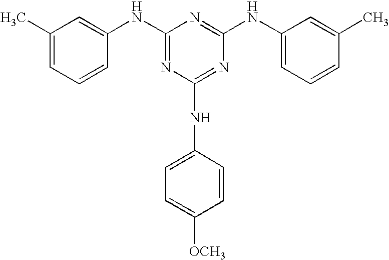 |
| 033 034 035 036 | Cpd.24-1 | 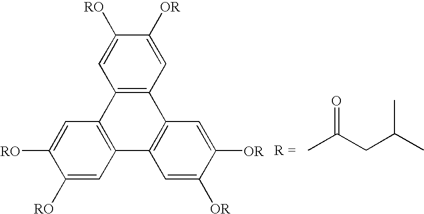 |

TABLE 3

| | | *1 |
|---|---|---|
| Type | Structural formula | 25° C. 10 kHz |
| Cpd. A-1 | 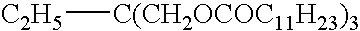 | 3.26 |
| Cpd. A-2 | 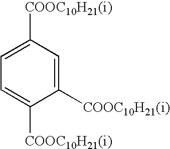 | 4.31 |
| Cpd. A-3 | 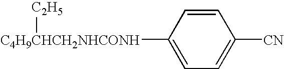 | 3.97 |
| Cpd. A-4 | 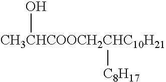 | 4.38 |
| Cpd. A-5 | 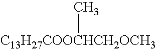 | 4 |
| Cpd. A-6 | 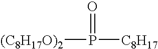 | 4.16 |
| Cpd. A-7 | 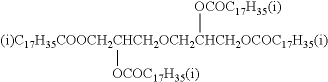 | 3.23 |

*1: Dielectric constant

TABLE 4

| | | *1 |
|---|---|---|
| Type | Structural formula | 25° C. 10 kHz |
| Cpd. B-1 | 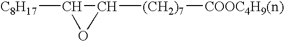 | 4.85 |
| Cpd. B-2 | 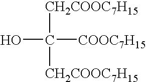 | 5.37 |
| Cpd. B-3 | 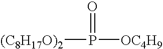 | 5.85 |
| Cpd. B-4 | 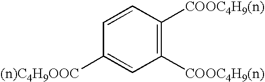 | 6.07 |
| Cpd. B-5 | 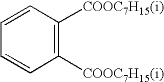 | 5.17 |
| Cpd. B-6 | 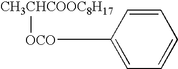 | 5.72 |
| Cpd. B-7 | 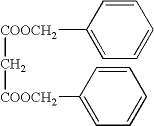 | 6.12 |
| Cpd. B-8 | 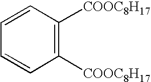 | 5.18 |
| Cpd. B-9 | 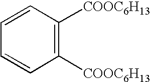 | 5.5 |

*1: Dielectric constant

TABLE 5

| | | *1 |
|---|---|---|
| Type | Structural formula | 25° C. 10 kHz |
| Cpd. C-1 | 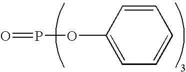 | 6.9 |
| Cpd. C-2 | 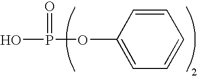 | 7.88 |
| Cpd. C-3 | 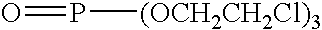 | 21 |
| Cpd. C-4 | 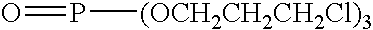 | 13.71 |

Table 1 indicates that according to the films of the present invention, optical films showing little light leakage and high retardations can be obtained. In contrast, none of the films of the comparative examples can achieve a high retardation and little light leakage at the same time.

### Example 2

<Construction of Polarizer>

PVA having an average degree of polymerization of 4000 and a degree of saponification of 99.8% by mol was dissolved in water to give a 4% aqueous solution. This solution was cast on a band and dried by using a tapered die so as to give a film having a width before stretching of 110 mm, thickness at the left edge of 120 μm and thickness at the right edge of 135 μm.

The obtained film was stripped off from the band and obliquely stretched at an angle of 45° in the dry state. Then, it was dipped as such in an aqueous solution containing 0.5 g/L of iodine and 50 g/L of potassium iodide at 30° C. for 1 minute and then another aqueous solution containing 100 g/L of boring acid and 60 g/L of potassium iodide at 70° C. for 5 minutes. After washing in a water tank with water at 20° C. for 10 seconds, the film was dried at 80° C. for 5 minutes to give an iodine-based polarizer (HF-01). This polarizer was 660 mm in width and 20 μm in thickness at both of the right and left edges.

(Construction of Polarizing Plate HP-01)

By using a polyvinyl alcohol-based adhesive, the cellulose acetate film 005 was bonded to one side of the polarizer (HF-01). Separately, a triacetyl cellulose film (FUJITAC TD80-U, manufactured by Fuji Photo Film Co., Ltd.) was surface-saponified as in Example 1 of WO 02/46809 and bonded to the opposite side of the polarizer (HF-01) by using the polyvinyl alcohol-based adhesive to give a polarizing plate (HP-01).

The transmission axis of the polarizer (HF-01) was located orthogonal to the slow axes of the cellulose acetate film 005 and the triacetyl cellulose film.

<Construction of Liquid Crystal Cell A-01 and Bonding to Polarizing Plate HP-01>

A liquid crystal cell was prepared by defining a cell gap between the substrates at 3.6 μm, injecting dropwise a liquid crystal material having negative dielectric anisotropy (MLC6608, manufactured by Merck & Co. Inc.) between the substrates, and then sealing to form a liquid crystal layer between the substrates. A retardation of the liquid crystal layer (namely, the product (Δnd) of the thickness (d) (μm) of the foregoing liquid crystal layer and the refractive index anisotropy (Δn) was set up at 275 nm. Incidentally, the liquid crystal material was oriented such that it vertically oriented.

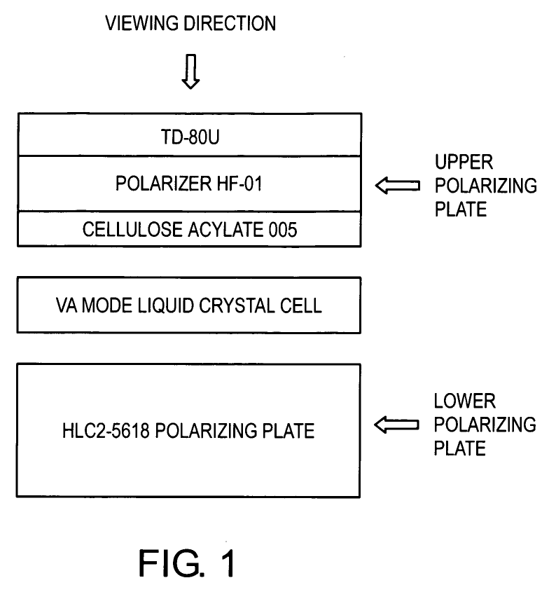

After constructing the liquid crystal cell, the polarizing plate (HP-01) was bonded thereto as shown in FIG. 1 to give a liquid crystal display device. Namely, an upper polarizing plate, the VA mode liquid crystal cell (comprising the upper substrate, the liquid crystal layer and the lower substrate), and the lower polarizing plate were laminated in this order from the viewing side (top). Further, a backlight source was provided. In the following example, the polarizing plate of the invention was employed as the upper polarizing plate while the marketed polarizing plate (HLC2-5618) was employed as the lower polarizing plate. Thus, a liquid crystal display device A-1 was constructed.

Another liquid crystal display device A-2 was constructed in the same manner but using the cellulose acylate film sample 001.

The front contrasts of the obtained liquid crystal display devices were measured in white and black displays.

It was confirmed that the liquid crystal display device A-1 thus obtained showed a small viewing angle-dependency of tint change, little light leakage and a high front contrast, i.e., having excellent performance with high visibility. On the other hand, the liquid crystal display device A-2 showed serious light leakage, worsened viewing angle-dependency of tint change and a largely lowered front contrast. (Referring the front contrast of the liquid crystal display device A-1 as to 100, the relative front contrast of the liquid crystal display device A-2 amounted to 88.6.)

Accordingly, it is understand that the polymer film of the invention shows desired optical performance over a broad scope and a liquid crystal display device having this film can provide an image of a small viewing angle-dependency of tint change and a high contrast.

The entire disclosure of each and every foreign patent application from which the benefit of foreign priority has been claimed in the present application is incorporated herein by reference, as if fully set forth.

What is claimed is:

1. A polymer film, which comprises:
at least one liquid crystalline compound; and
a compound having a dielectric constant ε of 4.0 or more,
wherein a haze of the polymer film is 1.5% or less.

2. The polymer film according to claim 1, which comprises a cellulose acylate.

3. The polymer film according to claim 1, which is formed by stretching.

4. The polymer film according to claim 1,
wherein a content of the compound having a dielectric constant ε of 4.0 or more is 5% by mass or more based on a polymer material of the polymer film.

5. The polymer film according to claim 1,
wherein the at least one liquid crystalline compound is a rod-shaped or discotic compound having three or more aromatic rings.

6. The polymer film according to claim 1,
wherein the at least one liquid crystalline compound is represented by formula (1):
Ar¹-L¹ [symbol] Ar²-L² [symbol] ₙ-Ar³ Formula (1)
wherein Ar¹, Ar² and Ar³ each independently represents an aryl group or an aromatic heterocycle;
L¹ and L² each independently represents a single bond or a divalent linking group; and
n is an integer of 3 or more, provided that Ar² and L² may be either the same or different.

7. The polymer film according to claim 1, which has an in-plane retardation and a retardation in a thickness-direction satisfying following expressions (A) and (B):
30 nm<|Re(590)|<300 nm (A)
30 nm<Rth(590)<400 nm (B)
wherein Re(590) indicates an in-plane retardation (unit: nm) of the polymer film at a wavelength of 590 nm; and
Rth(590) indicates a retardation in a thickness-direction (unit: nm) of the polymer film at a wavelength of 590 nm.

8. The polymer film according to claim 1,
wherein the compound having a dielectric constant ε of 4.0 or more is a compound represented by any of formulae (S-1) to (S-7): 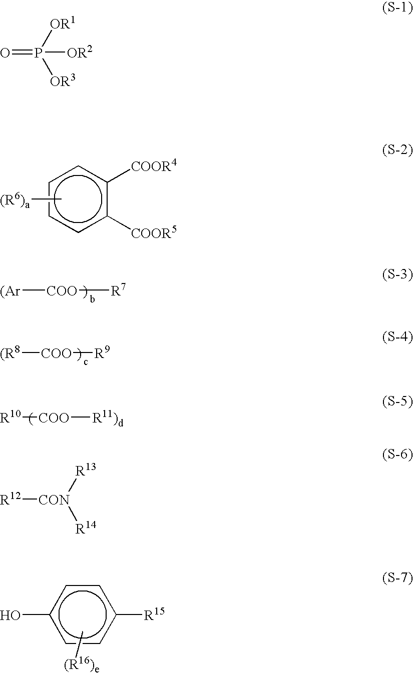
wherein in formula (S-1), R¹, R² and R³ each independently represents an alkyl group, a cycloalkyl group or an aryl group;
in formula (S-2), R⁴ and R⁵ each independently represents an alkyl group, a cycloalkyl group or an aryl group; R⁶ represents a halogen atom, an alkyl group, an alkoxy group, an aryloxy group or an alkoxycarbonyl group; and a is an integer of from 0 to 3, and when a is 2 or more, the plural number of R⁶s may be either the same or different;
in formula (S-3), Ar represents an aryl group; b is an integer of from 1 to 6; and R⁷ represents a hydrocarbon group having a valency of b or hydrocarbon groups bonded together via an ether bond;
in formula (S-4), R⁸ represents an alkyl group or a cycloalkyl group; c is an integer of from 1 to 6; and R⁹ represents a hydrocarbon group having a valency of c or hydrocarbon groups bonded together via an ether bond;
in formula (S-5), d is an integer of from 2 to 6; R¹⁰ represents a hydrocarbon group having a valency of d, provided that an aromatic group is excluded; and R¹¹ represents an alkyl group, a cycloalkyl group or an aryl group;
in formula (S-6), R¹², R¹³ and R¹⁴ each independently represents an alkyl group, a cycloalkyl group or an aryl group, and R¹² and R¹³, or R¹³ and R¹⁴ may be bonded together to form a ring; and
in formula (S-7), R¹⁵ represents an alkyl group, a cycloalkyl group, an alkoxycarbonyl group, an alkylsulfonyl group, an arylsulfonyl group, an aryl group or a cyano group; R¹⁶ represents a halogen atom, an alkyl group, a cycloalkyl group, an aryl group, an alkoxy group or an aryloxy group; and e is an integer of 0 to 3, and when e is 2 or more, the plural number of R¹⁶s may be either the same or different.

9. A polarizing plate, which comprises:
a polarizer; and
at least two protective films provided in both sides of the polarizer,
wherein at least one of the at least two protective films is a polymer film according to claim 1.

10. A liquid crystal display device, which comprises:
a liquid crystal cell; and
at least two polarizing plates provided in both sides of the liquid crystal cell,
wherein at least one of the at least two polarizing plates is a polarizing plate according to claim 9.

11. A liquid crystal display device according to claim 10,
wherein the liquid crystal cell is of a VA mode.
